(19) United States
(12) Patent Application Publication
(10) Pub. No.: US 2023/0044564 A1
(43) Pub. Date: Feb. 9, 2023

(54) Other Solution Automation & Interface Analysis Implementations

(71) Applicant: Joni Jezewski, Fremont, CA (US)

(72) Inventor: Joni Jezewski, Fremont, CA (US)

(21) Appl. No.: 17/444,286

(22) Filed: Aug. 3, 2021

(51) Int. Cl. G06N 5/04; G06F 40/30; G06F 40/247; G06F 40/166

(52) U.S. Cl. CPC G06N 5/04; G06F 40/30; G06F 40/247; G06F 40/166

(57) ABSTRACT

Solution automation & interface analysis components can be implemented in many ways, such as by specifying input/outputs & training a learning (generate, test & update) algorithm on the input/output data to generate a prediction function, to replace code connecting input & outputs.

Alternatively, additional specific example structure (like code/configuration/data) implementations to connect input/outputs of sub-tasks like core interaction functions & problem-solving intents to implement solution automation & interface analysis are included in the specification of this invention.

### FIELD

Embodiments of the disclosure relate to additional example implementation/application methods of the inventions solution automation & interface analysis, to implement or apply their components such as configuration, data & code.

### BACKGROUND OF THE INVENTION

Components relevant to fulfilling problem-solving intents (like configured problem-solving automation workflow insight paths, or generative functions of the same) can be found/generated/derived/applied with various methods, such as by applying structures of problem/solution components/variables/structures, as the examples included specify. The example applications & implementations in this disclosure specify configuration/data/code that can be used to apply/implement the inventions referenced in U.S. patent application Ser. No. 16/887,411 & 17016403. These examples extend the example applications & implementations referenced in U.S. patent application Ser. Nos. 16/887,411, 17/016,403, 17/301,942, & 17/304,552.

### BRIEF SUMMARY OF THE INVENTION

One or more embodiments of the present disclosure may include a method that involves:
problem/solution components
   solution/problem spaces
   related problem/solution networks
   solution metrics
   problem input & solution output formats
general problem-solving intents
   insight paths, including specific insight paths like solution automation workflows (insight paths that relate problem/solution formats)
   problem/solution metadata
      useful structures identified by or in relation to a particular problem/solution structure (like an interface query or solution automation workflow), as a source of variables to generate useful structures (like differences) in other workflows
      related object fit: conversions required to create this object from an adjacent/standard object of the same type
      simplification: standardized, simplified statement of the structure (like a simplified version of a workflow)
components to fulfill problem-solving intents
   problem-solution core interaction functions
   interface query-building logic (to generate interface queries)
   interface queries (to complete a task by connecting the origin input & target output, which may be a problem & solution format)
   interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’)
   functions to generate relevant structures for problem-solving intents, like ‘solution/error’ structures
   functions to apply core intents (generate/find/derive/apply) or problem-solving intents to problem/solution components like solution automation workflow insight paths & interfaces
   known useful components that can be applied as optional default solution structures to apply problem-solving intents
the examples in this disclosure involve example implementations or applications of these components.

### BRIEF DESCRIPTION OF THE DRAWINGS

Example embodiments will be described & explained with additional specificity & detail through the use of the accompanying drawings in U.S. patent application Ser. No. 16/887,411 & 17016403, which contain diagrams of the relevant program components (like solution automation module 140) where example implementations contained in this specification can be applied as configuration items, data, or code. The same applies for U.S. patent application Ser. No. 17/301,942 & 17304552, which also offer alternative examples of configuration items, data, or code of U.S. patent application Ser. No. 16/887,411 & 17016403.

### DETAILED DESCRIPTION OF THE INVENTION

As used herein, terms used in claims may include the definitions & term usage as detailed in U.S. patent application Ser. Nos. 16/887,411, 17/016,403, 17/301,942 & 17/304,552.
The term ‘implement’ a component indicates intent to ‘build’ a component, like ‘implement a function to reverse a sequence’ indicates ‘build a function to reverse a sequence’.
The term ‘apply’ a component indicates intent to ‘use’ a component, like ‘apply interface analysis’ indicates ‘use interface analysis’.
   The exception to this is where ‘apply’ is used in the context of the core intent function of the invention called ‘apply’, which refers to a specific invention function that ‘applies’ one component to another, like ‘applying an input to a function’, in the sense of ‘injection’ or ‘fitting/merging’.
These definitions are implied/referenced in the other applications & included to avoid conflation.

Examples of processes & structures relevant to problem-solving automation follow. Some of these items may be configuration in the system, such as definitions, examples, or rules stored in the database. Other items may be example applications/implementations/versions of the invention, or example processes relevant to applying/implementing the invention or different versions of it, or application/implementation logic of the invention.

Example of solving a problem on different interfaces:
general question answered by the interface query:
   how can structures of these interfaces be changed/organized to reduce/remove the problem or convert it into a solution
interfaces to format a problem on, with questions answered by that interface:
   structure:
      what are the problem structures
      what is the adjacent format for this problem
   info:
      what info is missing to solve the problem
      what info should be found/derived/generated in what structure (like sequence)
   potential:
      what alternative options are available to solve the problem
      is the problem possible to solve with adjacent resources, what alternative queries can be run in parallel to reduce solution space the quickest
   cause:
      what are the problem causes
      what causes can be used to justify interface query design intents & decisions
   change:
      what changes should the interface query support, and at what structures (like points in the logical sequence or tree)
      what changes to the problem can convert it into a non-problem or solution, what variables of the problem are relevant on some interface
   logic:
      what logical fallacies are possibly present or possible for this interface query? does it comply with logical rules like connecting info across interfaces (facts, assumptions, implications)
      what structures like connections fit (make sense), given how logic can be used to filter info structures (like by checking for multi-interface alignment such as aligning facts with logical connections)
   interface:
      how are these questions organized in a way to design the interface query optimally? (apply ‘potential’ filter first to make sure it's possible to solve)
      what structures of randomness or organization can be applied to the problem interface objects to make them relevant/useful for the problem-solving intent
   intent:
      what are the input/output intents of the interface query (input intent to solve a particular problem, output intents like emergent side effects of the interface query, like program optimization)
      what intents (of which functions, like ‘find info’) can the problem be represented as
   functions:
      what functions can construct (and by implication, deconstruct) the problem
   core:
      what core functions can be used to standardize the problem components

Example of integrating structures with methods like ‘connect’ (as a variant of standard ‘input-output sequences’, by applying ‘input-output sequences’ to ‘connect’ formats like ‘specific/abstract structures’, or connecting ‘value connections’ and ‘variables’ to create ‘functions’)
given how values can be connected, how can connections be connected using those value-connecting connections
   how can connections be formatted as absolute references (numbers) so value-connecting connections can be applied to connect connections
given that a function A connects 2 & 10, and so does function B, function B is connected to function A by change types & operations that preserve the input/output relationship for that case
in the space of connections, function A & B have a similarity in position
the efficiencies connecting two absolute references may replace another function connecting those references
   given the adjacence of 2 & 10 to each other, it may be more efficient to use this similarity to connect them (by transforming one to the other) than using other connections (either as similarities or differences) such as multiply by 5 or divide 20 by 10
   or it may be more efficient to transform 2 to 1 given its similarity to 1 and use unit multiplication (1*10=10, requiring no change) and transforming 1 back to two through addition (10+10=2*10) rather than multiplying 2*10
   this efficiency is generated from the metadata of these two numbers, metadata that may connect them more efficiently than other operations
      example queries:
         “apply the prime interface to connect numbers adjacent to primes” (adjacence given common factor pattern)
         “apply the unit interface to connect references adjacent to unit references” (adjacence to 1)
         “apply the difference interface to connect reference differences adjacent to a more computable/optimizable/efficient difference” (the difference between 2 & 10 is adjacent to the difference between 1 & 10)
         “apply the unit interface to the difference interface (find the core component of difference), then the alternative interface (replacing multiplication with addition)”
      interface queries can be framed as structural paths:
         value query:
         “take the prime network until you hit the unit network or am ambiguity, then take the difference sequence in the direction of increasing difference until you get to the target value”
         function query:
         “apply area operations (integral/derivative) until you reach a connection that can be reduced to coefficient operations (multiplication) or sequence operations (progressions, sums)”
         “apply difference operations (adding new difference types in values) until predictions of highly non-adjacent values are similar to actual values (converge)”
         “derive difference types in known input-output connections (local data) until interactive difference types (emerging in non-local data) are predictable with a degree of certainty”
         “determine difference types that are quickest to filter out (prove wrong), given common difference type patterns”
connection-connecting methods can be connected with interface components
   apply interface component ‘opposite’
      a function connecting 2 & 10 has an ‘opposite’ structure applied to the attribute of ‘direction’, in the form of a function connecting 10 & 2
      this absolute reference (opposite direction) connects these connection types (functions) just like −1 is connected to 1 by an opposite structure applied to the attribute of ‘direction’
   apply interfaces to get the metadata of a function (like we applied interfaces to get the metadata of values below)
      this will produce other functions that may be efficient in some way, possibly more efficient than the original function at many of its intents
   given that values can be connected with value-connecting metadata, functions can be connected with function-connecting metadata (and value-connecting metadata, given that values are components of functions and functions can be represented as values)
      just like 2 & 10 can be connected by their adjacence to primes, to each other, and to 1, functions can be connected by their adjacence to each other & to unit functions
   these absolute reference connections can be used to connect difference types
      “apply ‘opposite direction’ operations to connect a component to another, if they can be connected with a sequence structure (they exist or change in a space where a path can connect them, or in spaces that can be connected with a path)”

Examples of structure-connecting methods, like ‘absolute-reference’ connection methods
what is the complete set of unique connections between two values (numbers being absolute references), such as numbers like 2 & 10
   their metadata is connected with:
      similarities:
         components
         inputs
         factors (common factors)
      abstractions
         types
         value types (integers)
      system contexts (relevance through usefulness)
         applications
         common usage (commonly used as bases)
         usage potential (can be used to produce useful functions, sequences, & sets, like even numbers or digit-moving functions)
      relevant components
         relevance through adjacence in position
         adjacent value metadata (both near primes, e, pi, 1, & zero)
         relevance through interactivity
         interactive with value-connecting metadata (metadata like number types)
         intersections
         2 intersects with primes formatted as a sequential path (sequence of primes) or a network (formatted by adjacence to other primes, adjacence to other high-energy numbers, or other highly connecting metadata) or a function (checking for factors qualifying as those of a prime)
         sequence of even numbers
   differences like:
      adjacent transforms, formats, & applications
         usage
         power
         2 or its inverse is more commonly used as a power than 10 bc its one away from the unit power 1
   difference-reducing connections
      operations
         factors connecting the two numbers with multiplication/division like 5 & 20
these values can store different info with varying optimization/efficiency & varying info loss/preservation
given the ways that change types like variables/operations are connected in functions, relevant questions include ‘what functions efficiently connect values like the above pair, using minimal info, and for what intents’

Example of determining connections between useful alternative concepts for formatting (concepts like energy, entropy, random) to work around lack of other interface info
energy (in the form of cross-system interface components) can be stored in structures varying on cross-system interface component variables
   components like type, change, similarity, simplicity, stability, ambiguity, symmetry, interactivity, limit, efficiency, connectivity, & info preservation/compression
   a structure that can store some info has adjacent storage structures that can also store that info or a subset/parameters of it
the connectivity of these structures can be determined by the energy preservation/loss from origin/target structure and the structures enabling structures connecting them
these concepts are useful & structural enough that they can be used as metadata of a problem/solution that circumvents the need to structurize (apply structure to) a problem
   if you know the energy components of a problem and a solution, you can connect them with energy functions without structurizing the problem
   example:
      if a problem is ‘optimizing a system that wastes energy or degrades without maintenance processes’, and the solution is a method like ‘connect energy outputs with energy inputs’, these can be connected in either direction using energy metadata of interim steps/structures like ‘apply energy usage-reducing components like connections’ (to connect inputs/outputs), where energy is defined as common abstract structures like ‘source of change’, ‘output’, ‘input:output ratio’, ‘potential’, ‘robustness’
these concepts are useful bc they:
   can reduce info to its most relevant structures
      involve structures of relevance (commonness, abstraction, connection)
   apply to all interface components
      can be defined across interfaces (with alternative definitions that apply directly to interface components)
alternate energy formats:
   light
      light-filtering structures & containing structures like vacillations in a range (waves) around a symmetry (average) given a change-governing force (gravity)
      how would you format info as light
         light distributes/highlights/focuses energy on specific components, like objects within a distance range from a position, along a trajectory, at an angle, or with a particular interactive structure that absorbs or reflects light
         info has similar structures, like difference from origin info, info connectible on a path, info visible from a perspective angle, or interaction with info-absorbing/storing/reflecting structures like black holes or encryption algorithms

Examples of useful structures include:
input/output differences between alternative solutions
error structures like suboptimal interface queries, incomplete definition routes, sub-optimal/mismatched formats
requirements (useful for filtering by relevance)
intent maps (useful for connecting intents across interaction layers)
intent sequences
a ‘requirement to survive’ is the reason why an animal might develop bright colors, with varying intents:
with intent to ‘attract prey’, bc ‘prey are difficult to find’
with intent to ‘mimic a scarier animal’ bc ‘they're not scary enough to disincentivize predators’
with intent to ‘store excess mutations’ bc ‘mutations occurred for no reason other than structural damage’
the two intent sequences above overlap at the ‘bright colors’ node and diverge bc of different requirements, given their different positions relative to useful objects for survival (prey, predators, energy storage, change as energy)
this is a way to determine alternate causes of the same variable, given useful system objects like requirements & incentives
attribute sequences to connect problem/solution
example: a solution to this problem type has attribute sequence: complex, organized, filtered, isolated
counterintuition structures
example:
the insight that ‘over-prioritizing a priority usually invalidates the priority’ is counterintuitive but its true bc:
‘other priorities usually matter with equivalent or similar relevance, and prioritizing one priority over the others usually invalidates other similarly important priorities, creating error structures that break a system, reducing its ability to fulfill the over-prioritized priority’
with an exception that:
‘if the priority is determining of the system (the most important priority), it is not sub-optimal to over-prioritize it up to a limit, bc that wouldn't actually be over-prioritizing it, just allocating it the correct importance’
how to determine a counterintuition structure:
relevant variable and sub-problem/question sets to build interface queries around
‘alternate priorities’
key variable/structure: ‘alternate priorities’, which can be identified as possibly useful by applying core/commonly useful structures like ‘alternates’ to the problem system components (‘priorities’ in this problem)
key question: ‘identify a system with one priority’ and if a system fulfilling that structure cant be identified, its implied that ‘systems in general have multiple priorities’, which would invalidate applying the rule of ‘prioritizing one over the others’
‘unbreakable system’
key variable/structure: ‘unbreakable system’, which can be identified as the ‘contradiction’ structure of the insight rule by applying ‘opposite’ structures to the rule
key question: identify a system contradicting the rule, which cant be broken by positioning a priority (or other structures of intent, like requirements, outputs or function/structure intents) as more important than it is
if a system fulfilling that structure doesn't exist, its implied that ‘any system can be broken by over-prioritizing a priority beyond its actual importance/value’
how to prove this without combinatorial search:
apply ‘requirement’ structures as a ‘filter’ structure, to identify structures that are ‘opposite’ to requirements (don't fulfill requirements), such as ‘contradiction’ & ‘impossibility’ of requirements
   by applying ‘definitions’ of relevant components of the problem space to limit possible interaction rules:
      ‘if the definition of a system contradicts this possibility, no such system exists’
   by applying ‘input’ structures as a ‘filter’ structure:
      ‘if the inputs of such a system are impossible, no such system exists’
   by applying ‘possibility’ & ‘change’ structures as a ‘filter’ structure:
      ‘if systems where it is or would/could be possible cannot be produced by applying changes to the system in question, no such system exists’
function topologies as a useful structure (involving structures & structure change metadata that can maintain a particular function)
intent structures (like intent sets) associated with function topologies
even if a structure maintains a particular function, its other metadata like adjacent interaction/change types & intents may change with the structure change
intent topologies don't necessarily match metadata of function topologies, so the differences between these interface topologies is a useful structure as well
interaction of interface object topologies as a source of variance reduction
‘connections between solutions & interfaces having the intent interface applied’ (such as a goal like a solution priority or metric value) which makes them by definition relevant to solutions to problems involving that intent
by prioritizing different components (structures/attributes/interfaces), perspectives solve problem(s) in different ways, with different variables (problem origin points, solution metrics), and may solve different problem(s)
applying or integrating multiple perspectives can cover more problems solved or reduce the problems to solve, or it can create more problems depending on error types, like unnecessary abstraction or complexity added (in regard to complexity handled)
some perspectives are more useful than others for various intents
some perspectives need to be applied in structures (like sequences/combinations) with other perspectives
some perspectives will cause error types for an intent
examples:
if you think based purely on avoiding errors, you may miss optimal solutions
if you think based purely about functions & their interactions, you may miss how they fit into the system or how they apply to data
if you think based purely in sequential time, you may miss ways to parallelize operations

Examples of perspectives with associated solution/error structures like priorities/metrics
interface component perspectives
   ‘time’ perspective identifying time-based interactions of components
      the lifecycle timing of a solution/problem
      the sequential timing of steps of a process, like validations or functions to execute in a sequence
      timing variables like steps that should be executable external to a process or out of order in a certain context
      state sequence that should be fulfilled by a process
      imminent tasks to automate after this solution is complete
   ‘object’ perspective identifying object changes/structures needed
   ‘data’ perspective, identifying data flow, from origin state, to various alternative or sequential interim states, to target state
      the ‘data flow’ perspective aligns with testing of specific examples for entire processes creating the data flows & enables identifying/preventing data flow structures like differences or interactions that shouldn't be allowed
      as opposed to the ‘function’ perspective, the ‘data flow’ perspective focuses on inputs/outputs of logic, measured at various points in the process
   ‘system’ perspective, identifying system objects like duplicates, alternatives, efficiencies, ambiguities in data/logic
the system perspective offers a useful contrast with the data, variable, & function perspectives
   system: context where interactions of data, variables, functions, & processes are integrated in a way that is useful to agents
   data: examples
   data flow: sequential input-output examples
   variable: input structure (combination) options, change options
   function: input/output connection options
   function call stack: structures (container, combination, sequence) of input-output connections
   process: interaction objects in a system with agents
‘state’ perspective identifying state changes/structures needed
‘variable’ perspective identifying which variables are required for solving automation task problem before changing existing system
‘function’ perspective identifying which functions to write before implementing solution
‘test’ perspective identifying which tests the solution needs to fulfill (enables finding solutions by iterating changes & checking changes to see if they fulfill test)
‘error’ perspective that enables applying an ‘not error’ filter to solutions to avoid known/predictable error structures (like error types)
‘cause’ perspective identifying causal network of system components and which causes need to be changed to complete automation task
cause of logic selection in existing solution may be the sequence & existence of queries, whether the logic functions are available, & whether the logic variables are populated, whereas the target cause of logic selection should be which logic exists in a data store & the sequence of queries to that data store
‘logic’ attribute-connecting perspective (attributes like type-position)
   sub-queries about type attributes to solve problem of ‘finding correct position of components to fulfill organization intent’
      are certain types of logic better in different positions (validation in json dict, dependency changes in database triggers, parsing/testing in another position)
      what other types apply to logic (configuration, filters, data, examples)
   examples of logic attribute (type-position) connection functions
      if a logic type is configuration, that should be in positions associated with configuration
      if a logic type is changed more than other logic types, that may qualify as data
      if a logic type is an example, that suggests a testing position
attribute-specific perspectives
   ‘optimization’ perspective: identifying the most useful functions to write that optimize a metric (like ‘flexibility’) to the existing system (to support other intents), while fulfilling relevant problem-solving intents of the automation task problem
   ‘organized’ perspective that integrates solution with existing system of solutions & finds/handles error types
      apply interfaces to task & integrate interface objects into solution
      1. find variables of task (‘inject logic for specific cases’) first
      2. identify variable interactions & important error types to avoid with those variables
      3. design solution fulfilling foreseeable error types
         variables of ‘logic injection’ function (solution to automation task of ‘injecting logic in specific cases’):
         whether specific inputs have specific associated logic
         whether logic variables are available/populated in input
         whether logic functions in associated logic are available in execution context
         whether logic inputs are validated
         whether other specific cases are supported by ‘logic injection’ function
         whether specific cases of multiple injected logic components coordinate or contradict each other
         whether outputs of injected logic components suboptimally change inputs of other injected logic components
         whether injected logic components have a correct sequence and whether it aligns with injection sequence
   ‘efficient’ or ‘default’ perspective with low learning curve (adjust existing logic & write tests, don't change anything that isn't necessary like rearranging components)
      apply most granular change & add changes/logic as necessary to support future intents
         apply most adjacent solution (add specific conditions to actual logic)
   ‘consolidated’ perspective with low maintenance requirements
      move logic to position with best available testing, validation, processing functions
   ‘reusability’ perspective enabling future usage
      keep logic in position enabling future usage intents
   integrated ‘consolidated’ and ‘reusability’ perspectives
      keep logic in position enabling future usage intents, but add function to convert to position with best functions to support those intents (testing, validation, processing functions)
structure perspectives
   ‘limit’ perspective
   identify limit of implementations & identify whether usage will converge to limit
      implementation limits:
      will adding granular specific cases directly to existing solution ever hit a point where its sub-optimal
   limit convergence:
      are we near that point or will we be in the lifecycle of this solution
‘filter’ perspective
   identify which filters exist & how to change them to implement solution
      existing filters: conditions, dependencies, constants, validations
‘interaction’ perspective
   identify how system components interact & how to change interactions to implement solution

Example of applying known solutions to various related & sub-problems to fulfill problem-solving intents (solve the ‘task automation’ problem)

1. problem of ‘dependency’ between logic components
apply ‘dependency’ definition
   separate dependent variable logic & apply after initial logic once inputs are populated as constant independent inputs

2. problem of ‘dependency’ between problem/solution components (solution steps)
solving problem 3 would occur before solving problem 4 given the sequence formed by their required inputs

3. problem of ‘selecting which implementation to use for primary automation task’
select between strategies
   inject variable to store logic & apply if populated (store logic in database table)
   embed logic in other logic (store logic in query logic)

4. problem of ‘selecting format to use once an implementation is selected’
select between logic formats
   delimited format
   actual logic format
   logic standardized to executing language format (python)
   logic standardized to common format (json dict) to be used as config vs. data in a data store

5. problem of ‘finding correct interaction level to apply solution at based on interaction interface’
interaction level: process, query, task, script, variable, function
interaction interface: usage interface, logic interface, input/output interface, state interface

6. problem of ‘finding intents supported by implementation options’
storing in database supports intent of ‘fast initial querying & re-querying, & subsequent querying’
storing in python support intents of ‘maintainability, modifications to add new logic, consolidate to process/step interface’

7. problem of ‘finding related & aligning intents of ‘enable injecting logic in query logic’ automation task’
testing logic correctness:
   determining difference in inputs/outputs, as aligning with differences applied in logic (input/output difference created by logic & input/output data difference)
testing updated logic:
   determining difference in original/updated outputs (original data & updated data with new function to inject logic for cases)
a difference-determining function would be useful for both of the above intents

8. problem of ‘finding correct structures to approach problem’
‘organize problem components’ intent
   position (as an input to the ‘organize problem components’ intent)
      find correct position of components
         logic, input/output/interim/duplicate/index data, validation/generative functions
‘reduce solution space’ intent
   filters
      apply organization intent with regard to solution filters (as an input to ‘reduce solution space’ intent)
         tasks, processes, process variables, process steps, required inputs/outputs, and cost of implementing re-arrangements

9. problem of ‘finding functions to solve these problems & selecting the functions that solve the most problems to write the least code’
functions that solve the most problems out of problems 1-8 & fulfill the most perspectives (fulfill the most perspective-associated solution metrics)
   function to determine (data/logic) difference
   function to find required/similar logic/data
   function to convert logic to a format
   function to sort (logic/data) in sequence
   function to apply logic based on variable (execute specific logic for an input, or a specific input to execute a process step logic)

Examples of other solution structure metadata include:
related object fit (how it fits to other objects of the same type, such as a different variant/version of another object of the same type or a combination of other objects of the same type)
simplification
important differences (output difference)

Examples of interface query design rules
‘if solution requirements aren't given, derive/predict them or apply default requirements from related/similar problems’
add error type prioritization to resolve competing error types, or error types like ‘contradictions between success signals’ that result from different success signal sources/relevance
example: the ‘ego’ comes from ‘self-protection’ intents and its success signals may contradict success signals produced by other sources like ‘sensory info’
   alternate ways to resolve this contradiction:
      apply the insight ‘over-prioritization of a priority results in contradiction of that priority’
      identify if general/specific ‘self-protection’ intents or other high-priority or relevant intents are invalidated by choosing a particular success signal source
      identify if the inputs of one success signal are more relevant (such as involving ‘specific, accurate, useful info’), or if they are independent of other more relevant success signal sources (‘success signals produced by prior success, rather than the accuracy/relevance of current success signals’, or ‘health success signals’ which may be unrelated to/independent of ‘current success signals’)
         the reason success signals may be produced by a suboptimal method may be because the success signals are produced by default by the system or from another source, rather than bc they are accurate signals of good decisions
explanation of why some structures overlap across interfaces & how to select a base interface to define these structures in
   examples:
      ‘opposite’ or ‘neutral’ has a clear math definition, and also a clear structural definition, for any non-mathematically defined structure
      ‘valid’ is a logic interface, system interface, & math interface concept)
   different interaction types:
      one interface may define the structure, and another may apply it
   interfaces may have different definitions of the structure while still referencing the same underlying structure, meaning the concept is abstract but acquires different structures in various interfaces
   interfaces have other interfaces injected in them by default
      example: every interface has the core interface injected, bc it has core components
   there's usually one interface that is the base interface for any given structure
   if a concept is abstract & relevant to multiple interfaces, it may be a core or required component of multiple interfaces
   apply structures to overlaps in definition routes
      find the adjacent structure without contradictions, that doesn't resolve to either specific option, within the limits of both definition routes
         lack/limit: resource
         function: resource
         resource-generating function: resource
         resource: function
use isolatability/inevitability/uniqueness as a structural foundation for interface conversion/generation logic
   identify ‘inevitable’ definition routes that are unique which can be used as a default generation intent for the core data included for app functionality
      example: a definition route that cant be used as a definition of both balance & power, just one
      unique intents are also a useful foundation structure for the intent interface

Example of different structures of an interface component on different interfaces
alternative
   ‘structural alternative’: where one or more structures are options where one or the other or both if not mutually exclusive can be chosen (applied at a given time), with varying relevance/optimization, for a particular intent (like ‘navigate in a direction’, having structural alternatives in the form of a set of paths)
   ‘conceptual alternative’: where one or more concepts can be applied at a given time with varying relevance/optimization for a particular intent (concepts with an intent in common)
   ‘structural conceptual alternative’: alternative conceptual structures, like varying structures of power or balance
alignment
   ‘structural alignment’: based in the structural interface, where a ‘structural alignment’ takes the form of an equivalence/similarity in components (attributes/functions/objects/structures), such as:
      interchangeable attributes/functions/objects
      a fitting/matching structure
      a parallel structure
      a structure having similar shape or other attribute like size
   ‘conceptual alignment’: translated to the conceptual interface, an ‘alignment’ takes the form of concept such as ‘equal’ and/or related concepts like ‘similar’
example of injecting the structural interface to components on other interfaces:
   a ‘structural conceptual alignment’ is the ‘alignment’ in structures of concepts, like ‘similar conceptual connections’ or ‘equivalent concepts’

Example of applying interfaces to the math interface to map math concepts to other interface components
number: all possible values (and value types, like units)
variable: all possible change types
function: all possible equivalent variable/value interactions
   recursion: all possible self-references
   multiplication: all possible value interaction spaces
   division: all possible value standards
   polynomial: multi-variable pattern alignment (alignment of multiple added terms at regular intervals creates waves where the inflection points represent alignments in values or a pattern in alignment of neutralizing values)
function input variable: all possible change types that can be causes
space: value interaction space where variable (change type) interactions have structure (can be described)
structure of a group/combination, like continuity such as a line or shape: a generalization/abstraction/variation of a point/value
   the opposite structure would be a condensation/compression/specification, condensing a structure into a point
structure of an average: a standard value to base conversions on

Example of an insight-fitting interface query for fulfilling the problem-solving intent of ‘avoiding error types’
when a new discovery is made, apply insight paths formatted as questions like the following to identify error types before they occur
   could this violate any assumptions/requirements/dependencies we rely on for other tasks like calculations or applying systems of understanding
   could this cause known error structures like cascading (self-sustaining) errors, or emergent errors, given other knowledge like probably interactive trends or rules
   what are triggers of this discovered connection? what can it trigger with certain interactions, & how likely are those interactions to cause errors?

Examples of problem-solving intents
apply interface components, like insights
select a problem/solution structures (core interaction function, solution automation workflow, interface query, definition, format sequence, etc)
select/derive any missing problem/solution structures, like solution metrics
apply solution structures (followed by a ‘check for solution metric fulfillment, to test if the solution structure solved the problem’)
check for errors
filter solution space
select between alternative similar/equivalent solutions
check for solution metric fulfillment
store/get/apply useful structures
select which structures to store in database for later re-use

Example of an interim solution:
‘use exclusively solution with known biases & error types so output can be corrected with logic from the associated solution type’
   algorithms that don't have a mechanism to offset/correct biases from data can be used with a correcting function to improve output likelier to be an error type
   this is an interim solution (algorithm/model+correcting logic of error types) while other algorithms are tested
   every algorithm has limitations—those with known limitations can be an asset in some problem types (like to discover biases in data), while other algorithms with unknown limitations can be an asset in other problem types (like to add uncertainty or delegate responsibility for unfair decisions)

Example of applying concepts to math structures to identify metadata like ‘solution success cause’ for particularly useful math structures which can act as components of solutions
useful math structures with useful relevant concepts
   subset: useful bc it acts as a structure of ‘simplicity’ like a ‘unit case’ or a structure of ‘variation’ by creating variety in various subset combinations or a structure of ‘assumption invalidation’ by removing assumed connections (like those between a complete variable set and a dependent variable)
   opposite: useful bc it acts like a ‘contradiction’ structure, a useful source of ‘filter’ structures
   average (center): useful bc it acts as a structure of ‘unity’ or ‘origin’ or ‘commonness’ (the factor the numbers around the center/average have in common)
   tangent: useful bc it acts like an ‘interaction’, ‘intersection’, ‘approximation’ or ‘similarity’ structure

Example of standardizing an error type
‘maximizing shareholder value’: using outputs (profit) to attract investment/capital rather than re-investing in products
   calling ‘routing outputs’ function with intent to ‘get more required inputs (like capital)’ as a replacement of calling ‘routing outputs’ function with intent to ‘make required inputs optional’ has error structures with varying degrees:
      false trade-off (not mutually exclusive)
         outputs can be divided between both intents to create short-term & long-term gains
      false causal structure
         routing outputs with intent to ‘increase product quality/variety’ would fulfill the intent of ‘attracting investment/capital’
      over-prioritization
         short-term gains
         over-prioritization of inputs (like ‘resources/ability’) rather than using inputs to reduce costs (like ‘required inputs’)
      lack of solution structures (once structures like over-prioritization are noticed, no solution structures were there to offset it)
      lack of alternatives (other alternatives to ‘increase product quality’ to offset lack of intent fulfillment in the ‘output routing’ functions weren't in position or available)
      lack of opposite structures of competitor success (no monopoly or competitive moat or platform/supply chain/regulatory advantage in place)
      lack of incentive structures to improve product in the absence of solution structures or correct output-routing functions (if executives planned on quitting/retiring before problems were noticed or compensation regulation changed)

Example of multiple ways to solve a problem
multiple ways to solve the ‘find if a particular number is in a random sequence & find its position’ problem
iterate through the sequence & check
filter the solution space of all possible sequences & approximate an answer by checking various points with solution filters
   apply the definition of generative function's ‘random’ definition if available to identify error types possible/expected
   apply the general definition of ‘random’ and ‘probability’ to find filter structures of likely sequences, which has probability-based filter structures when applied to a ‘random number sequence’ structure, like:
      the sequence structure is likely to not have clear patterns in it (patterns that imply that it can be reduced to a function other than a random function)
      the sequence structure is likely to not have a pattern that applies to the entire sequence (a pattern may occur, but is likely to only occur in a subset, the larger the sequence is)
      if most positions do not have the number, its likely that remaining positions do have the number given possible patterns not ruled out by most positions (rather than finding a long sequence that doesn't contain the number, which is less likely than most numbers appearing in a long sequence at least once)
      apply patterns of probability patterns as filters
         how likely is it that ‘if most positions do not have the number, it's likely that remaining positions do have the number’ produces an error?
multiple ways to solve the ‘answer a question automatically’ problem, with the following interface query:
   if you have question-answer pattern info:
      apply those patterns of language map routes or other info structures in the pattern to produce the answer
   if you have error type & solution format or known solution info:
      identify error type & apply solution formats or known solutions for that error type
         apply the solution format as a template with a ‘missing’ error type or ‘identification’ problem:
         for the question ‘how did they get from A to B’, the ‘missing’ structure is a ‘missing path connecting the points’, and the identification problem is selecting the correct route from all possible routes connecting the points
         apply known solutions for the ‘missing’ error type (like ‘matching structures that fit missing structure’) or the ‘identification’ problem (like ‘apply probability-based filters’)
   if you have concept identification, system structure identification, & derivation functions & access to info like agent decision histories but don't have specific info to filter possibilities of the optimal solution format of ‘who drove it’
      derive understanding of ‘decisions’ objects (to drive a car) & give proxy/approximate/abstract answers based on understanding
         for the question ‘who drove the car’, derive relevant concepts such as ‘inputs’ to ‘driving a car’, like ‘incentives’, ‘functions’, ‘access’, ‘requirements’, ‘intents’ to ‘drive a car’ and produce a set of abstract descriptions of the types of people with those intents/incentives & other related objects

Example of finding useful structures like ‘average’ to find relevant variables like ‘difference from average’ in a ‘find a prediction function’ problem
if a simple algorithm identifies ‘difference from an average’ as a variable of a prediction function for ‘health problems’, other useful structures may be applied to align the meaning of the structure, like ‘abstraction’, so the ‘difference from an average’ is not applied to the ‘specific’ average of that initial training data set, but rather from the average of ‘any’ data set (calculated dynamically according to the data set average value), if thats relevant for the specific problem, and if error types of that structure are not relevant
   this would indicate that its any difference from the average that leads to differences in ‘health’, rather than a specific difference from the average of a particular data set
      but if the specific average happens to be the same as the absolute average or is a common average across data sets, this adjustment may not be necessary to the simplistic ‘difference from average’ prediction variable
      adjustments to the simple structure should be made where necessary to improve problem-solving intent fulfillment (improve the prediction function)
   often a problem wont be as simple as finding one particular important structure
   this simplistic algorithm that just checks for ‘difference from average’ to predict ‘health’ would have errors like missing relevant structures such as:
      ‘difference from average in an interactive community’
      ‘difference from absolute average’
      ‘skewed data filled with outliers from many communities, which seem like the average in the skewed data set’
how would it identify ‘average’ as an important object for the ‘find a prediction function’ problem?
   this problem has sub-intents:
      ‘find differences between data points’, which has sub-intents:
         ‘compare data points’
         which has related objects like ‘average’ or ‘standard’
         these related objects enable comparison, similar to ‘centering’ a line between points or ‘normalizing’ a variable value, which remove the common factor by creating an average in the form of a common distance from the regression line or average value (0.5 between 0 and 1), allowing the remaining non-common difference (which the two data points don't have in common) to be clearly identified (difference from regression line or difference from 0.5, rather than difference from 0), bc the average value has meaning in the form of being more common so difference from it also means a ‘lower probability’, not just a ‘difference in value’
the ‘average’ can be important for the ‘find a prediction function’ problem bc it allows for comparison between data points to find differences that can be used as variables to build the prediction function
in standard terms, the ‘average’ can be useful bc its a possible relevant object/input/sub-intent to a sub-intent (compare) of a sub-intent (find differences as variables) to implement a method (build) of fulfilling the original problem (find prediction function)
so we know the ‘average’ can be a useful structure—how do we know ‘difference from average’ is a relevant variable of the prediction function?
   we are looking for variables, which by definition involve changes to values, so applying ‘differences’ to already identified useful structures is a way of finding possible variables
   then, applying standard methods, ‘difference from average’ is a relevant variable if it has predictive value across data sets
we are making assumptions:
   the data set involves interactive data point sources
   other useful structures don't apply, such as ‘alternate causes’
   the reason an outlier may have differences in ‘health’ may not be bc of ‘differences from average’ but another cause like ‘randomness’ or ‘interactivity between similar data points’ (meaning interactions with similar data point sources is an alternate cause of health differences)
so applying known general useful structures:
   alternate causes
   abstraction
   assumptions
   core structures like ‘average’ & ‘difference’
to a problem structure & input (data set) creates relevant structures to the ‘find a prediction function’ problem, like:
   relevant data set differences (variables)
   differences between data sets (alternate samples)
   ‘difference from average’ as a predictive structure
      variants of ‘difference from average’ by applying:
         relevant attributes like ‘interactivity’
         variants of input structures like a ‘community data set’ rather than a ‘data set distributed across non-interactive communities’
error types
   ‘false similarities’ in data sets
   two data sets may be equivalent for different reasons (‘alternate causes’), such as one group is healthy in one data set bc of missing variables, like proximity to lab testing center, and is healthy in the other data set bc they're more average, and healthy in another data set bc they interact more & share medicine
   ‘many outliers in a data set’ indicating a ‘false signal’ error type of the ‘absolute average’
   ‘missing variables’ from the data set
   ‘missing variation’ in different data sets
these structures are necessary for creating a robust algorithm to create a prediction function, bc a typical algorithm will not infer all of these structures bc they are not directly in the input data set points, variables, or their direct interaction spaces containing their connections
these structures can be embedded with pre-processing in the input format, but that can lead to problems if processed/embedded incorrectly according to the processed structures' actual meaning
using ‘0.5’ as input instead of the ‘average health data point’, which may or may not be a predictive structure (‘difference from average’) and may be calculated incorrectly (should be a difference from a different average) so embedding it with a manual standardization may lead to other errors
   this would inject a certainty in the input data that may be an error or an uncertainty or may not be resolvable with the existing data
also, pre-processing for one of these structures may contradict pre-processing for another structure
an algorithm would identify & apply these general useful structures to create relevant useful structures for solving the problem, adjusting the structures as needed to improve the problem-solving intent fulfillment

Example of identifying useful info formats for intents & apply to fulfill those intents given the metric those formats fulfill (like ‘minimizing cost’ or ‘reusing resources’)
rather than a language map, other useful info formats may include:
   a map on a different interaction level, like ‘core components’:
      a component language map (common core components of other terms) with words graphed as queries of the map
         this would be useful for intents like the following, bc these involve adjacent attributes/functions/structures of this info format:
         ‘build a language map query like a particular word query’
         ‘find similarity between words’
         ‘generate a new word’
      a network of common query structures on the language map (what are the words used for, like common sentence patterns such as questions)
rather than an attribute graph, containing a network of grouped attributes as objects:
   a network of attributes as nodes
   a network of individual attribute networks
rather than a causal network diagram:
   a causal diagram with specifically n-degrees of causal inputs mapped
   a set of vectors pointing in the same direction of other caused nodes (as vectors) with magnitude indicating input directness degree (root cause being shorter to indicate earlier position in the causal sequence)
   clustered nodes by the outputs they have in common
rather than a system network diagram:
   a network of functions that can generate/describe it
rather than a variable network:
   a set of example system networks that include those variables as attributes of objects as network nodes

Examples of additional solution automation workflows
apply structures of useful interface components (like structures of specific useful concepts)
   example: ‘apply concepts to system interface to identify useful conceptual structures in system’
      system
         system structures of uniqueness: exclusivities
         system structures of power: trigger, input
identify & apply inputs of problem/solution components
   insights/insight patterns: identify the variables of insight generation (such as structures like difference types/degrees, like ‘applying a mixed different/similar system with various difference/similarity types to another system, with intent to understand the other system’) and apply these variables to generate insights that can be applied to solve a problem
apply interfaces to problem/solution structures to general useful structures for problem-solving intents
   intent: derive intent maps & align intents on multiple problem/solution structure layers, like problem-solution connection and sub-problem or problem/solution component connections
   logic: derive interactive structures given logical rules like equivalences/implications used as connecting functions
   definition: apply problem/solution structure definitions to determine their possible interactions
   cause: find solution success cause and generate solution automation workflows from that
   change:
   find changes to problem/solution structures that still allow the structures to interact
   find remaining variables of interactions
identify alternate problem/solution structures like alternate core interaction functions (‘improve’/‘optimize’ a standard/default solution, ‘progress’ or ‘move’ toward, ‘connect’ with) between problem/solution structures
   identify & add other core interaction functions (like ‘isolate/separate’) in problem/solution interaction space to create solution automation workflows, since creating barriers to separate a problem from the problem space or separate a problematic structure from its required inputs is a possible solution format
apply solution automation workflows to solve problems like ‘identify structures of obviousness’ to generate solution structures to other problems
   example: apply the ‘reverse-engineer’ solution automation workflow to identify/generate useful structures (like structures of ‘truth’, such as ‘obviousness’) using useful structures like ‘opposites’ to identify & apply ‘filter/limit’ structures of what a ‘structure of obviousness’ cannot be
   workflow fit: this applies solution automation workflows to generate inputs to solution automation workflows, like ‘solution structures’ like ‘truth structures’
   this is similar to the ‘apply problem/solution structures to other problem/solution structures’ workflows & variants, but specifically applies workflows to generate inputs to these workflows, applying structures like ‘combinations’ to workflows as needed to fulfill the ‘generate workflow inputs’ intent, specifically for ‘solution structures’ inputs in this example, rather than other solution structures/metadata like ‘solution success cause’
   the above example uses a combination structure of the ‘reverse-engineer’ workflow (applying the ‘apply useful structures’ workflow, and the ‘filter solution space’ problem-solving intent to do so) as a component to fulfill the general workflow of ‘identify/generate solution structures & apply as components of solutions’
simplification: this applies general solution structures like ‘solution automation workflows’ to solve general problem-solving intents like ‘finding components of solutions’ for other problems
apply core interaction functions & core structures to useful structures to identify generate & apply other useful structures as solution structures
example: apply the concept of ‘probability’ to generate useful structures, which would produce a query like ‘identify probability structures like patterns of useful structures’
workflow fit: this may have the same output as other workflows but it involves applying the insight that ‘core structures of useful structures’ which benefits from the usefulness of the concept of ‘adjacence’ in that core structures (like combination of useful structures, or patterns of useful structures) will probably also be useful structures
generalization: other useful concepts & interface components (like ‘adjacence’) can be used to generate insights (like ‘core structures of useful structures are also likely to be useful’) that can be used to generate solution automation workflows (like ‘apply useful structures like the concept of probability to identify/generate other useful structures that can be used as solution structures’)
identify structures of useful interface components that can be used to generate/identify other useful structures
   example: identify useful structures (like patterns) of useful structures
      example pattern of useful structures: ‘structures having a higher number of useful concepts it can function as’
         example of a structure having a high number of useful concepts it can function as:
         tangent: useful bc it acts like an ‘interaction’, ‘intersection’, ‘approximation’ or ‘similarity’ structure
workflow fit: this applies useful structures to themselves to generate useful identification/generation structures of those structures, given that they're by definition useful
   this is similar to workflows involving ‘apply useful structures to find useful structures’ or a variant of it, but specifically applies useful structures to create functions to identify/generate other useful structures
      example: the function created above is ‘identify structures matching the useful structure that is the structure of a pattern of useful structures “structures having a higher number of useful concepts it can function as”’
         the ‘structure’ of useful structures is the ‘pattern’ of useful structures
      this translates structures (like patterns or combinations or input-output sequences) of useful structures into specific structures (like ‘structures with a higher number of useful concepts it can function as’) that can be used for effective identification/generation of specific useful structures (once formatted in a useful format, like the ‘structure-function-concept’ format) & applied as solution structures in a specific problem space
      this is generating what amounts to ‘insight paths’ to connect general useful structures with a function to identify specific useful structures, using connecting rules like ‘standardize structures to various interfaces or interface structures, like combinations of interfaces, and then identify useful structures like patterns of useful structures’
      it also adds the ‘standardization to various interfaces’ step, which adds variation in the solution space of possible useful structures to search
identify useful structures for depicting interface components (like change types), particularly useful structures (like ‘adjacent structures in different formats’), and apply these structures to create solution structures (like structures of clarity/obviousness, where the info made clear by that structure is useful for problem-solving intents)
example: a graph of a topology of properties indicating the change types that break properties or produce phase shifts in properties to show change structures
solution success cause:
   why is it easier to solve problems when they are graphed? bc of structures of truth like clarity/obviousness given focus/implications produced/prioritized by certain formats
      connections are implied with default adjacent or otherwise obvious structures, like a line that completes a triangle when added to an angle structure formed by two lines where the missing line is the same length as the other lines
      some structures are clear in different formats, like differences or patterns being more visible from one angle than another
apply useful selection rules to identify a structure to structurize a system in a useful format that applies solution structures like structures of certainty/optimization for problem-solving intents like ‘to make the solution trivial/obvious’
   workflow fit: this workflow is to ‘apply insights that map structures by relevance across systems’ which is a variant of a combination of the ‘apply problem-solving insights to solve problems’ and ‘apply structures of relevance to fulfill problem-solving intents’ workflows
   a structure should be used to graph a component when the particular structures made obvious/clear by that graph format are required or otherwise useful
   example:
      a ‘unit case’ structure is useful to answer the question of ‘whether a possible connecting rule is true at all’
      a ‘contradiction’ structure is useful to answer the question of ‘whether a connecting rule is absolutely true’
   the selected structure should be able to maintain the relevant structures (such as structures of interaction, equivalence/difference, change) of the origin system if its going to be useful in depicting interactions in that system, which implies the relevant structures are already identified in the origin system
   if other formats can make other attributes/functions of a system obvious, those other formats can be integrated into a combination/merge or other structure of formats to gather info about the origin structure
   abstract & query for structures or structures (combinations/subsets) of structures from the origin system in other systems and filter other systems by which systems:
   have more of these structures
   are capable of more of these structures
   aren't missing any of these structures by definition/requirement
apply the insight that ‘adjacent structures are a form of obvious structure’, so construct structures where the required connections will be adjacent:
   to connect ‘two opposite unconnected sides of structures with a common connected origin’, specify these structures as math structures to format it as a ‘set of lines with a common endpoint’, at which point the connection between endpoints will be obvious
   how do we know the connection between endpoints will be obvious in that format, before applying it?
      bc ‘connections between structures’ are just a ‘line structure’ in that space, which is an adjacent connection, adjacence being a structure of obviousness
   how do you find a space where a structure to fulfill an intent like ‘connect unconnected structures of two structures connected at a common origin’ will be an adjacent structure?
      identify the requirements of the connection structure (like ‘connect differences of this type’), and remove structures that are not relevant to it (like the general ‘structure’ term instead of a specific term like a ‘line’, and the general ‘origin’ term instead of a specific term like ‘comment endpoints of lines’), and find a space where the remaining structures can be depicted
      the term ‘origin’ is not relevant to solving the problem of ‘connecting the other opposite unconnected endpoints of the two lines’, all thats relevant is that there is one set of endpoints that are connected and the other endpoints are not, so that term can be specified/generalized as needed to standardize it to the new space where this connection resolution is obvious
   identify adjacent components of the problem space and identify spaces where those components can exist or be applied
      identify adjacent components (like the existing components of the problem space, like ‘structures that can be connected’ and ‘origins’) and check if those components can be added or otherwise operated on in the new space where the connection resolution is obvious
      example: identify a space where ‘connection structures’ can be added (where ‘lines can be added’)
   iterate through variants of the problem space components (like ‘connection structures’) to find possible specific/general/other variations of the structures & associated spaces
      variations of ‘connection structures’ include ‘lines’ in associated spaces like spaces greater than 1d
“identify a structure (like ‘connected lines at an endpoint’) where unconnected structures of difference (like ‘unconnected endpoints’) can be connected using adjacent conversions
adjacent conversions like ‘adding objects equivalent to themselves’ (a third line) or ‘rotate to form a 3d object’
this ‘two connected lines at an endpoint’ structure would be useful to depict structures like the following, where the implied third line is required to solve some problem:
   ‘two alternate definitions (or types/variants) of an object & the structure to connect these definitions’
   a ‘route to maximize distance traversed in different directions with minimal turns’
   the ‘magnitude of a vector to connect two similar objects depicted in a vector space with an angle indicating their similarity, where magnitude indicates object type’
identify solution success cause of ‘why a structure is useful’ (or specifically why its useful for an intent) & apply that to identify other useful structures as needed to solve a problem
example:
   some structures are useful by definition bc they ‘fulfill a requirement’, which is a definition route of ‘relevance’ which involves ‘usefulness’ as one of its definition routes
   others are ‘probably useful’ bc they tend to fulfill a general solution or optimization metric like ‘reducing complexity’ or ‘increasing coordination/organization’
   some structures are only useful in a particular context, like how structures of ‘counterintuition’ are useful for intents like ‘prevent errors’ in ‘complex system’ contexts
why is a structure made useful (in the form of ‘obviousness’ of a solution) by a particular format?
   bc its standardized in some way that allows for clear implied connections between useful structures like equivalences/similarities/differences to be made
   example: the example of ‘two lines of equal length connected at one endpoint to form an angle’ has a clear implied connection between the ‘unconnected endpoints’ which has another ‘degree of implication’ added by the ‘equal distance between the unconnected endpoints’ which has another ‘equivalence’ structure in the form of “equal length to the other two sides' length”, to resolve the implied ‘difference structure’ that is the ‘distance between the unconnected endpoints’
      these equivalences between side lengths form an implied pattern structure:
         two line lengths are equal
         the distance between unconnected endpoints is a third equal side, forming a pattern of equivalences in side lengths, given the addition in the pattern sequence of another line object having an equal length attribute value, after applying a ‘sequence’ structure to the first two lines
      a difference structure offers a connection between this initial equivalence (equivalence between ‘existing line lengths’) and the next equivalence (equivalence between ‘existing & missing line lengths’) by identifying the missing line as a relevant difference
         this structure can be identified as ‘missing’ or a ‘relevant difference’ in the first place by applying:
         the identified ‘pattern structure’ to generate implications like the third value in the pattern sequence
         the ‘similarity structure’ in ‘change type’ between the endpoints and their starting point (they have a similar position away from the connected endpoints forming the angle, and this similarity in position to that connected endpoint structure makes them comparable, and comparing two endpoints of an angle structure leads to a connection between them, as in a third line connecting them)
      these two equivalences form another equivalence:
         the equivalence between ‘equal line lengths’ and ‘missing line length’ of the implied third line in the pattern sequence
      another structure of ‘obviousness’ implied by this ‘angle between two lines’ structure is a ‘cone’ bc adjacent structures like a ‘rotation function’ are also structures of obviousness
   workflow fit: this is similar to the ‘identify problem/solution structures (like solution success cause) of problem/solution structures (like useful solution structures)’ workflow, but adds the connection to ‘system contexts’ where a particular structure is relevant
identify patterns in differences in useful structures in various systems (like structures of ‘requirements’ in various systems) to identify variables of how a structure should be changed to become useful in a particular system, as well as the differences between useful & non-useful structures in a particular system compared to each other & compared to the system structure, to identify probable useful structures given a system structure
   generalization: this can be generalized to ‘identify the differentiating variables of the most useful structures to compare & identify the most useful structures to compare, to enable optimal identification of these structures which are directly relevant for problem-solving intents’
      useful structures to compare:
         useful/non-useful structures
         useful structures vs. system structure
         error structures vs. solution structures
         patterns of difference between formats that can identify different attributes/functions/structures
   workflow fit: this is similar to the ‘identify useful structures (like patterns) in useful structures to identify/generate them, & apply them as solution structures’ workflow, but generalizes it to all problem/solution structures, and adds a core interaction function of ‘comparison’ to ‘connect the structures that are most useful to differentiate’, an intent that is particularly useful for problem-solving intents when applied to problem/solution structures
apply variance structures like ‘approximation’ using useful structures like ‘adjacence’ to other required or otherwise useful structures like ‘input output sequences’ to generate sources of variation to apply to problem/solution structures like workflows to generate different structures, such as ‘apply adjacent transforms to input-output sequences to find adjacent input-output sequences to use as solution structures as well as the structures required to solve the sub-problems of converting to those adjacent structures’ instead of ‘find all currently possible input-output sequences to find solutions using only existing resources’
applying ‘adjacent structures’ to useful structures benefits from the usefulness of ‘implications’ to connect structures where no clear connections are available with existing resources, just like how other problems benefit from the usefulness of ‘approximations’ or ‘formatting to make structures obvious/clear’ where previously their connections were not available/feasible in another format or with another input
workflow fit: this is a variant of the ‘apply useful structures to find probable structures of certainty/usefulness’ workflow, but is specifically applying useful structures with intent to create variations of useful structures which may be more possible or more useful for some intent than using the exact/existing useful structures
solution success cause: this works bc existing useful structures may fulfill some high priority intents, but it may fulfill them suboptimally, so only filtering the solution space by these structures will restrict the solution space to sub-optimal solutions, ignoring alternatives that may be accessible with adjacent structures like existing conversion functions
   this also works bc variants of useful structures may benefit from their similarity to useful structures, in that they have similar outputs (being similarly useful) while allowing for differences in intents fulfilled
generalization: apply useful structures like ‘similarity/adjacence’ to create other useful structures like ‘differences’ in inputs to allow for useful structures like ‘differences’ (useful for problem-solving intents) like an ‘increase in optimization’ in outputs (like ‘solution metrics’)—‘differences’ being a specifically useful structure to apply to sub-optimal existing solutions, which are a default/input structure justifying usage of this workflow
identify which solution automation workflows or interface queries would produce solutions according to an optimization metric of solutions determined to be sufficient (like computational complexity, speed, accuracy or efficiency) and use this as a filter of possible solution workflows/queries generated by default methods like ‘trial & error’ (search all possibilities) or by applying other workflows to generate solution structures
if a solution method is slow, its unlikely to be an effective application of a workflow, so avoid that and exclude it from initial rounds of solutions generated/applied
example: in the ‘find a prediction function’ problem, applying ‘adjacent changes’ as a useful system structure is a component of various workflows/queries, but it is only useful in some positions of the problem space
if you apply ‘adjacent changes’ to the function itself, it will produce many versions of the function that require testing & further adjustments, and you would need to apply an effective search/filter method to reduce that solution space, like applying ‘adjacent changes’ to known positions of limits of the function where it wouldn't likely have structure
if you apply ‘adjacent changes’ to other problem space components, like ‘variable structures’ or ‘data sets’, you may generate useful output for various intents like ‘identifying variable structure causation’ and ‘data augmentation’
if you apply other useful structures like ‘base’ to the ‘adjacent change’, to find ‘adjacent changes that produce a base’ to the function structure, that could be useful bc then you're looking for a conversion function between functions, which is a quicker task to solve & more optimizable
by definition, ‘methods that use a lot of resources’ are not usually optimal problem-solving methods, so that can be used to filter the set of generated solutions created by applying useful structures or by other methods
applying ‘adjacent changes’ to known solution structures is one way of creating efficient methods, bc by definition ‘adjacence’ requires less resources, so these are likelier to be efficient solutions, if they qualify as solution structures according to other metrics
workflow fit: this is similar to ‘apply useful structures of solutions like efficiencies to generate/filter solutions’ but is specifically prioritizing low-cost optimization metrics as a required input to generating/filtering possible solution structures (including workflows/queries) to avoid applying any queries/workflows that are unlikely to be optimal in some metric, which is particularly useful when many possible solution structures are generated & need to be filtered, which applies the definition of efficiency structures like ‘adjacence’ to generate the insight that ‘workflows/queries that aren't adjacent are by definition unlikely to be efficient’ and applying this insight to determine a starting point for the workflow & applying it as a solution structure filter (solution automation workflows & interface queries, in addition to solutions)
simplification: this can be simplified to ‘if its not quick, its not a shortcut’ given the definition of a shortcut, which is the structure that makes some solution-finding methods more powerful/optimal than others
generalization: other structures that are required inputs given the definition of solution automation workflows & other problem/solution structures can be used as a method of filtering/generating the solution space or other solution structure
identify alternate causes of solution success as generators of solutions:
the reason a ‘function network’ or ‘state simulator’ or a ‘stacked alignment’ may be successful as predicting interactions may not be bc of the structure itself but bc of one of its outputs, such as:
   a ‘dependency’ or ‘interaction’ structure caused by a ‘function network’ structure
   a ‘state sequence’ caused by a ‘state simulator’ structure
   a ‘phase shift bc of a threshold crossing’ caused by a ‘stacked alignment’ structure
these useful output structures can be caused by other structures:
   a ‘dependency’ structure can be caused by a ‘containing’ structure forcing that specific ‘input-output sequence’ to develop, caused by for example a ‘lack of functionality’ rather than ‘connected functions in a function network’
   a ‘state sequence’ can be caused by an ‘interactive, adjacent, & probable structure filter set’ structure
   a ‘phase shift bc of a threshold crossing’ can be caused by a ‘lack of input validation’ structure
identifying variables of the solution success cause allows different solution causes to be identified & applied as solution generators
workflow fit: this is similar to ‘identify & apply solution success causes as solution generators’ but abstracts it & applies a higher causal node as input to ‘solution success cause’ as the ‘causes of solution success cause’
generalization: this can be generalized to: ‘identify generators of useful solution structures or identify alternate routes to useful solution structures & apply those alternate routes or generators as generators of solutions’
solution success cause: this works bc there isn't usually one input to the success of a solution, allowing for the usefulness of alternate inputs to solution success, and these inputs can be generated, and there are ether useful solution structures than solution success cause that this rule can be applied to as well, to generate solutions using other useful solution structures
identify differences in interface queries, workflows & other problem/solution components that can be used to solve the same problem & apply those variables to generate possible/adjacent solution queries or solutions given a base solution or just given the variables
the output of this would include workflows like:
   input-output sequence & ‘build’ core interaction function structures: ‘find the “input-output sequences” that build/produce the same output solution from the same input problem, with a given range of difference in input context (robust solutions), to build/produce/process the solution structure info from the problem structure info’
      note: this is particularly useful bc it abstracts away causality & functionality, leaving just ‘available resources’ (inputs) and ‘outputs’ as the factors to analyze, so it could be specified as ‘causal input-output sequences’ or ‘function input-output sequences’ but that may be unnecessary in some circumstances where that info is irrelevant or captured in the abstraction of the ‘input-output’ structures
   format/state sequence & ‘connect’ core interaction function structure: ‘find adjacent “format sequences” that can “connect” a problem/solution’
   generative variable structures: ‘find “generative variables” of a problem and reduce those instead’
   interactive structures & ‘build’ core interaction function structure: ‘find interactive/cooperative structures in a problem space and use those to build a solution’
a workflow that can generate all the relevant structures used to build these workflows could be:
   identify attributes/structures/components that are interchangeable (‘format’, ‘input/output’, ‘interaction’) and apply them to fulfill a structural requirement (a structure that can be ‘connected’) to solve a problem (‘connect’ problem/solution)
   solution success cause: this works bc if components are interchangeable, they can be changed to generate differences that don't alter the input/output/functionality of the original structure
   generalization: this can be generalized to the workflow ‘identify variables of workflows that don't invalidate functionality of workflows & apply variables to generate different workflows’
   workflow fit: this is similar to ‘identify differences between solution automation workflows & apply variables to generate different workflows’ but is a specific variant that identifies differences in specific queries/workflows used to solve the same problem which are standardized in some way for comparison (all of the above compared workflows use ‘connect’ or ‘build’ interaction functions and a ‘sequence’ structure in some position), and applies useful interface components such as concepts like ‘interchangeability’ to generate insights like ‘use interchangeables to generate different workflows’ to apply these insights as generators of workflow-generating functions
apply structures of interface components as filters when predicting unknown systems
   example: using just info about inputs/outputs of a cell and one of its components like DNA, predict all the other interactions/components/functions occurring inside a cell
      apply higher-certainty interfaces like insights, system, core, & potential structures to generate a set of possible default components (like sub-systems or sub-components that can exist in the cell) based on insights about:
         system structures like efficiencies in the form of energy usage
         potential-impacting structures like limits in the form of contradicting rules preventing a structure from occurring
         given info like the cell's attributes like size, the inputs available given the cell's inputs & the outputs of components & their interactions given the cell's outputs
      once this set of default components/functions is generated, filter it by applying other interface components (like intent) to add extra certainty
         interface component combination structure (intent+cause+change as sequential filters):
         intent: this set of components/functions is possible (given a sub-system that could stabilize given how efficiency works in the form of energy usage in biological systems), but is there an intent associated with it? what agent would benefit from its existence? is there a reason for it to exist? does its outputs benefit any other system?
         these questions can filter the set of possible components given structural system insights & core structures by intent, bc structures don't usually exist persistently if they are not useful to some other system
         this filter could be replaced with a ‘relevance’ filter
         cause: this set of components/functions is possible & there is a reason for them to exist, but is there a cause that could produce them (and would produce them, given its intent to do so)?
         change: this set of components/functions is possible, there's a reason for them to exist, and there is a cause that could produce them, but can it be changed in a way that would invalidate it and are these changes likely, or are there changes that would produce more optimal functionality for some higher priority intent and are those changes likely?
         interface component contradiction structure (error as a contradictory structure of the above interface component sequential combination filter structure)
         error: is there a way for a component/system to stabilize without these attributes or in contradiction of these attributes? (is it possible for a component to be independent of the other components but still exist within a system like a cell, like an output of evolution that isn't necessary but hasn't been removed yet, or a particularly efficient/useful component, or a component that causes problems but hasn't been handled yet bc they are lower priority or relatively lower in impact/scale of problems caused)
workflow fit: this applies the concept of ‘multi-interface alignment’ to fulfill the problem-solving intent of ‘filtering the solution space’, which is similar to ‘applying interfaces in an interface query’ but is different in that it specifically applies combinations of ‘cooperative/aligning’ interface components as ‘filter’ structures to apply when identifying ‘probable solution structures’ based on ‘multi-interface alignment’ as a source of certainty, given that ‘cooperative/aligning structures’ tend to be likelier to be true/real bc they add value such as ‘efficiency’ to a structure (‘sharing resources through cooperation’) so theres a reason to use those structures over other structures, and this is also similar to ‘applying certainty structures as a source of solutions’ but acts as a variant of both workflows that also combines them
   applies specific certainty structures like attributes such as ‘alignment’ from the ‘applying certainty structures’ workflow
      applies the insight that structures with attributes like stable/cooperative/efficient are likelier to be true, and applying this insight & related certainty structures to ‘interface components’
   applies ‘apply interfaces in an interface query’ workflow, but specifically using interfaces that are organized by certainty structures:
      “combine interface components in a way that fulfills the ‘multi-interface alignment’ or ‘cooperative’ structure”
   a specific highly useful interface query like this can function as a solution automation workflow
      not all interface queries are useful for all problems, but some are, like this one, so it qualifies as a solution automation workflow
   combines the two workflows (with a standard problem-solving workflow of ‘filtering the solution space’):
   apply the interface query of “filter the solution space by applying ‘structures of multi-interface alignment composed of interface components’”
   this may be the same output as the output generated by another interface query or solution automation workflow, but it differs in route applied to generate it (the ‘combination’ structure of solution automation workflows), and this route can be used to generate other workflows/queries
output difference:
   this workflow's output interface queries differ from other interface queries
      example: applying the ‘break a problem into sub-problems & merge sub-solutions’ workflow generates an interface query like:
         sub-problem: identify solution space of possible components
         sub-problem: reduce solution space (identify probable components)
         sub-problem: identify components that can be used as filters or components of solutions
         sub-problem: apply ‘concept’ interface, specifically the ‘probability’ concept, to identify common components in other structures of bio system
         sub-problem: apply ‘core’ interface to identify core components in other structures of bio system
         sub-problem: apply ‘pattern’ interface identify patterns in differences between containing structure & component structures, from other structures of bio system
         sub-problem: apply filters to possible structures to identify remaining probable solutions or apply components as possible structures to build probable solutions
         sub-problem: check if solutions pass solution metrics
         note: the indentation indicates the integration/merging level of sub-solutions
      this interface query also identifies filters of possible components, but using a different route, bc it implemented a different solution automation workflow (‘break a problem into sub-problems & merge sub-solutions’) as opposed to the other workflow (‘apply structures (like combinations) of interface components fulfilling metrics like ‘cooperation/alignment’ to build/identify structures that fulfill metrics like multi-interface alignment as a source of certainty’)
      this workflow can be generalized to:
      ‘apply structures of interface components fulfilling useful metrics to build/identify solution structures that fulfill any useful (like ‘certainty’) structures involving interfaces’
apply general useful structures to find probably relevant useful structures in the problem space, as a way of filtering problem-solving intent fulfillment components, like solution inputs or solution components
this is a proxy for knowledge, to replace rules like ‘augment the data set with variants of it’ with general structures like ‘apply core structures like difference to all problem inputs like data sets’ and ‘find error types like false similarities with alternate causes’ (in relevant problem structures like ‘equivalent data sets with different causes of their patterns’)
an example is applying ‘difference’ & ‘average’ to find ‘difference from average’ as a relevant structure that may be an input to the ‘prediction function solution’
solution success cause: this works bc these general structures are known to occur & be useful across systems for variable problem-solving intents and are therefore likely to interact, meaning they are relevant for finding & connecting interactive structures of a problem/solution, by applying the general structures to the problem space to find specific relevant structures to connect
workflow fit: this is an extension of the ‘apply useful structures’ workflows, with the application of additional filters for relevance of structures, like ‘contradicting error structures’ and ‘position’ of the useful structures once specified for that problem space
   for example, positioning a useful structure in the input data may not be correct for the ‘find a prediction-function-finding algorithm’ problem bc that may not be a meaningful position where it is useful to other structures
apply difference patterns between assumed/implied/actual meaning as a way of correcting false implications/assumptions to connect structures without explicit known connections
apply differences that cause errors in the fewest possible cases as a way of changing a problem into a solution or changing a solution to a similar problem or changing other problem/solution structures for problem-solving intents
identify & apply non-standard intents as ways of finding useful structures for problem/solution intents like ‘core interaction function’ intents
   example: apply alternate definition routes of ‘power’ & ‘truth’ to fulfill core interaction functions like ‘connect’ to fulfill a non-standard intent of ‘power structures’ (intents such as ‘finding truth structures’, like facts)
      alternate definition routes of ‘power’ include:
         ‘ability to produce changes’ bc power indicates an input to functions, where functions produce changes like new/altered components
      alternate definition routes of ‘truth’ include:
         ‘stability/reliability’
      implied related power/truth insights given connections of definition routes
         if a structure is powerful, it can produce changes
         an absolute or input truth cant be changed, even by powerful structures
         if many powerful structures cant change a particular structure, that indicates the structure is true (true in the form of ‘stability/reliability’)
      so ‘power structures’ have a non-standard intent of ‘finding truth’ by applying ‘power structures’ to produce changes (an output of power) to see if some structure can be changed
         this intent connects alternate definition routes & implications of ‘power’ and ‘truth’
         these concepts are by default connected in the insight ‘truth is a form of power’ (applying this insight is not required but it is relevant)
      how would you know to use ‘power structures’ to fulfill the intent ‘find truth structures’
         bc the two concepts are connected by their alternate definition routes:
         power produces changes
         truth cant be changed
         power can used to determine if something can be changed
         if it cant be changed, its true
         the important part is identifying ‘change’ as a connecting structure between the two concepts, and identifying that one (power) produces an opposite structure (change) of the other (truth, which is stable/reliable), so it can be used to find ‘not truths’, and therefore can be used to find ‘truths’
         so ‘power structures’ have a non-standard intent of ‘finding truth’ which is a relevant intent to problem/solution intents like ‘filtering the solution space’
      this can be generalized to identify & apply useful structures with non-standard intents that produce other useful structures like ‘truths’ relevant to problem-solving intents
      workflow fit: this involves identifying useful structures for problem-solving intents (like truths) as a problem to solve (‘find useful structures for problem-solving like truths’), in addition to other general problems to solve when problem-solving (like ‘filtering solution space’), which differentiates it from other workflows, bc these useful structures are inputs to general problem-solving intents so they can act as a new general problem-solving intent
once problem/solution structures are combined & filtered for workflow structures/types like difference-maximizing workflows or base workflows, and further filtered by which combinations fulfill problem-solving intents, further filter the set by which combinations fulfill differences that are also structures of relevance for those problem-solving intents
   workflow fit: this is an extension of the workflow ‘combine problem/solution structures (like core interaction functions & error structures & workflows) or change workflow input variables to create a set of all possible workflows & filter the possible workflows by metrics like relevance to problem-solving intents & interactivity’, extending it by an additional filter, to filter out workflows that differ by structures that are not relevant to some problem-solving intent
   if a workflow differs from other workflows, it should differ in a way that is relevant to fulfilling a problem-solving intent (some workflows may differ in ways that are not useful for a problem-solving intent, so this filters them out)
identify which interface structures fulfill problem/solution structures on different interfaces & apply those structures to fulfill those problem/solution structures
   example: identify which intents & intent structures (like which sub-intent structure solution metrics help fulfill the general solution metric intent) fulfill solution metric intents (like ‘keep this variable below this threshold value’) & apply these intent structures as solution filters or solution components
   this applies across interfaces:
      identify intent metrics that help fulfill a problem/solution structure metric (like a core interaction function or a solution metric)
      the general version of which is ‘identify attributes that help fulfill a problem/solution structure attribute’
   solution success cause: this works bc the same format is being applied to fulfill core interaction functions for problem/solution structures, and some formats can be used to fulfill core interaction functions on their own
      this should allow structures that are not standardized to the same format to be connected as well, using the version of a format in that structure
      example: you don't have to standardize every structure to the ‘intent’ or ‘solution metric’ attribute interface if you know the corresponding structures of those structures in the current formats
workflow fit: this is similar to ‘standardize to the same format by applying an interface and apply interaction rules of that interface to determine structure interactions’ but is specific to the interface structures that help fulfill problem/solution structures & allows them to be mixed with other formats using corresponding equivalents rather than forcing all structures to be standardized, and involves matching structures of problem/solution structures with those of other problem/solution structures (matching ‘intents of sub-problem solutions’ with ‘original problem solution metric intents’), given how the fact that a solution metric of a sub-problem may be relevant to the solution metric of the original problem, which is a possible structural relevance that allows these components to be relevant in a way that allows one (sub-problem solution) to predict the other (original problem solution), so that structure (sub-solution/solution metric) is a useful format to use to fulfill interaction intents (like ‘connect’) between these structures (sub-solution metric & solution metric)
derive & apply interaction rules of useful cross-interface or useful interface components (efficiencies/alignments)
to answer questions like:
   with what ‘frequency’ can a ‘random combination’ of ‘alignments’ create an ‘efficiency’ in a given ‘system’?
having variables:
   solution formats
      certainty (probability, frequency, average)
         format solution as ‘certainty of a particular structure given inputs’ rather than other formats like ‘method to generate a particular structure given inputs’
   solution filters
      requirements
      intents
   problem space
      system context
   interactions
      applicable connecting logic rules
      attributes (random, adjacent, difference-maximizing, similar, opposite)
      structures (combination, subset)
   interacting components
      useful components (alignments, efficiency)
   identifying useful cross-interface interaction rules
   examples:
      ‘merge difference types’ function
      ‘common relevant efficiencies’ structures
      ‘find simplifying/generative/change-generating function’ function
   how to identify useful cross-interface interactions:
      structures of useful components from one interface applied to another interface
         example: useful structure interface components (combinations) of useful system components (incentives, ambiguities) applied to other interfaces
      useful interaction structures of relevant problem-solving structures (like core interface structures or problem interface structures like errors)
         ‘merge’ is a useful interaction structure of error structures like ‘difference types’
         ‘common relevant efficiencies’ combines multiple useful interface structures/attributes to create a useful structure for ‘fulfilling an intent’, which is relevant to ‘problem-solving’
identify & apply generative functions of cross-interface interaction rules (like structure-concept interactions) & useful cross-interface interactions & cross-interface interactions between useful structures
   example:
      structures that generate function to ‘merge difference types’
      structures with conceptual attribute ‘relevance’:
         a ‘database index’ structure gathers & searches just the information useful for ‘find’ intents based on structures of standards like ‘what is commonly searched for’ and ‘what varies across data’ and ‘what combination of fields uniquely identifies/differentiates data’, so it can be used to fulfill intents like:
         intent: ‘identify unique records’
         fulfills ‘unique combination’ standard
         intent: ‘find records quickly by only searching relevant data’
         fulfills ‘what is commonly searched for’ standard
         intent: ‘differentiate records’
         fulfills ‘what varies across data’ standard
      applying the above structures of standards as solution filters can find the ‘database index’ structure in the ‘search database’ problem space
      the solution creates an efficiency for the 3 ‘search database’ intents, while creating inefficiencies for the ‘minimize storage’ & ‘generalize solution’ intent
      these intents could be fulfilled with modifications to the ‘database index’ solution:
         ‘minimize storage’: store static values in a nested index
         ‘generalize solution’: apply ‘database index’ solution dynamically or for other queries or query types
      interface query to generate implementation of this cross-interface interaction
         identify variables
         core variables (data set format/stores/store format/store fields/store records, search method, sort method, storage method, query)
         variable combinations
         data set/store-query relation
         search-sort relation
         apply requirement filters to solution space:
         iterating data of some format is required
         apply variable expansions to solution space:
         apply probability interface to ‘input/output formats’ structure:
         data doesn't have to be in original input format or output format of ‘common’ queries
         apply change interface to ‘input/output formats’ structure:
         data doesn't have to be in a static format
         apply structural interface:
         data can be in ‘multiple’ formats
         data ‘subsets’ can be stored in addition to the ‘complete’ data set
         apply structure filters:
         what structure in the ‘search database’ problem space can identify unique field combinations, enable quick searching for common searches, and differentiate data (even if it differentiates them incompletely, or to a contextual definition of ‘differentiate’)
         apply differences to variable values to generate core adjacent combinations of variable values
         store subset of rows for a query type (search only these rows for queries involving these fields/operations/conditions/values)
         store subset of fields (search only these fields)
         store subset of example rows with allowed variation (search for these examples for these queries & anything adjacent to the example)
         store data patterns to search for a query (search for these patterns for these queries)
         filter combinations by usefulness for ‘search database’ problem intents
         apply filter with ‘system optimization’ (‘only add required functionality’)
         which of the combinations fulfills the above 3 intents without fulfilling extra unnecessary intents (aligned demand/supply of intents)
identify & apply interaction structures (like core interaction functions such as ‘connect’ or core interaction structures like ‘combination’) to solution structures (like solution automation workflows or known solutions) to solve general related/sub-problems of problem-solving (‘filter solution space’, ‘select solution metrics’) to generate solution automation workflows
   related component (workflow) fit (position in network of related components): this formulates the task of ‘generate solution automation workflows’ as a set of problem structures (like related/sub-problems such as ‘filter solution space’) to solve with queries (like ‘find solutions to the problem of filtering the solution space’ or ‘apply interaction structures of known solution structures to create new solution structures to fulfill general problem-solving intents like filtering the solution space’)
identify ‘difference’ structures between known problems/solutions & apply them to possible solutions to see if it becomes more like a solution/problem structure, to test if it fulfills a solution format
   if you apply ‘differences’ known to differentiate problems/solutions to a possible solution, it should become more like a problem if its originally a solution, so this is a way of identifying solutions
apply ‘implications’ as local units of interaction & meaning, since an ‘implication’ is a logical extension of a rule system that makes sense (‘fits the system’ or ‘has meaning in the system’), unless contradicted by some interaction
   any structure (like conclusions/insights/facts) can be units of interaction/meaning as well, but implications fill in the gap when there isn't a known factual rule to predict interactions between structures
   example: if a function fulfills a specific ‘reduction’ intent (like ‘reduce a sequence’), that implies (but doesn't mean) it can fulfill a general ‘reduction’ intent (like ‘reduce any input’), but the implication means this function can be tried as an initial possible probable solution, before trying other functions that don't fulfill any ‘reduction’ intents, and its likelier to fulfill the general intent, unless other solution structures/workflows identify more optimal functions for that general intent
   implications are a useful structure to specifically fulfill the ‘connect’ core interaction function on the problem/solution interaction layer
   this can be generalized to find other structures that are useful to fulfill other problem/solution core interaction functions, or other intents in general, and the structures that fit the best for a core interaction function or another intent can be derived rather than configured in a database (stored in a static known rule like ‘select implications to fulfill connect intents’)
   workflow fit: this is similar to ‘applying solution structures as components of a solution or to fulfill a core interaction function’ or ‘apply relevant structures for problem-solving intents’ but specifically identifies the structural alignment between ‘implications’ and the ‘connect’ core interaction function as a useful way of selecting useful structures (implications) to fulfill that intent when other common problems (like lack of information) to problem-solving in general are present
identify general structures associated with solutions to general/core problem formats (efficient filters, optimal routes, cost-minimizing structures), even if they're not directly relevant to the original problem format, and apply them as default or component structures to build a solution out of or apply them to fulfill a core interaction function of the problem/solution structures (like ‘reducing’ the problem)
   workflow fit: this is different from the ‘apply solution structures’ workflow bc it abstracts the solution structures (applying general solution structures) & connects them to the structural interface (the system-structure interface structure of ‘efficient routes’, as opposed to the system interface structure of ‘efficiencies’, or the structure interface structure of ‘shortest route’) & applies all of them as components of the solution, rather than filtering solution structures to select directly relevant structures to the problem format
   this workflow can be generalized to include other cross-interface structures to connect structures in a useful way across interfaces, given that the problem/solution structures may not be in a particular format like the structural format or the abstract format, so cross-interface structures help fulfill intents like ‘connect’ without applying the interface to all the problem/solution structures
   example of applying other interface structures:
      adding other general system optimization structures like ‘stability’ can fulfill intents like ‘filter’ better, like to ‘filter/reduce the solution space’ for general intents like ‘finding solutions quickly’
         a ‘stable efficient route’ is likelier to be optimal bc the solution will be robust to change as well as minimizing cost & fulfilling the original problem intent of ‘connecting source/destination nodes’
      adding other interface structures like ‘cause’:
         a ‘highly causative efficient route’ indicates the route is a powerful input to other structures, which can be useful for solving related similar problems like ‘connecting adjacent source/destination nodes’ given that the route has a high usage rate which implies it may be used to connect other nodes, so this structure is useful on the problem/solution interaction layer (useful for other related similar problems)
   solution success cause: this works bc cross-interface structures are useful for fulfilling intents like ‘connect’ without applying the interface to all structures, and bc the cross-interface structure is likelier to be interactive with any given interaction layer than either of the one-interface formats
apply structures of meaning to find relevant (useful, interactive) problem/solution structures (like core interaction functions such as ‘connect’ that fit with structures like ‘causal sequences’) & apply those to fulfill problem-solving intents, solution automation workflow intents, interface query design or sub-query intents, or core interaction function intents
   there are many different structures of relevance in the problem/solution interaction space, such as inputs (problem cause, error types) and outputs (solution metric filters, solutions)
   this is why there are many different solution automation workflows, and many differences in applicable workflows even between equivalent problem/solution formats
   the relevant structures are ‘meaningful’ to find a ‘solution’ for the ‘problem’, sometimes meaningful by ‘connecting’ or ‘merging’ the problem/solution, by ‘building’ one or the other, ‘deriving’ one from the other, ‘invalidating’ one or the other, etc
   structures of meaning could be a ‘causal input/output function sequence’ for a ‘connect’ core interaction function, or a ‘filter function sequence’ for a ‘reduce’ core interaction function applied to the ‘solution space’ in the workflow
these structures are meaningful bc they are useful to each other in some way, such as interacting bc they fit together (like how an input interacts with a function bc it fits its input requirements)
the workflow would involve deriving structures that fit together in a meaningful way to fulfill a core interaction function intent & using those as building blocks of solutions, or that fulfills a solution automation workflow intent
workflow fit: this workflow generalizes other workflows & adds applicability to multiple layers of the problem-solving intent stack
reduce problem/solution structures into known error structures & check the produced variants of those structure to see if they have known solutions, if they generate a solution, reduce/change the problem or the need to solve it
example: for the ‘find a prediction function’ problem, reduce the data set by ‘human error patterns’, the output of which may overlap with the output of other commonly applied methods like ‘data augmentation’, ‘data reduction’ or ‘data subset sampling for cross-validation’
reducing the data set in this way may reduce the problem of ‘finding a prediction function’, or the data set may not have much variation once ‘human error patterns’ are removed from the data set, reducing the need to solve the problem with a more complex method (the resulting data with ‘human error patterns’ removed may have a clear pattern that simple methods can output a prediction function for)
if a complex/noisy data set can be reduced into a straight line by reducing it by ‘human error patterns’, ‘outlier patterns’, ‘noise patterns’ or with operations on variables to correct variable error types (like removing redundant variables or combining variables into a type), the problem structures may have been distorted and may be inaccurate
   this applies an insight like ‘simpler connections are likelier bc they require less work (are more adjacent) and stable systems tend to minimize cost to maintain stability’ (Occam's razor)
   if an insight indicates the possible presence of an error structure (like a structure of improbability) in a problem/solution (such as an improbably complex/noisy data set), that error structure should be addressed & the problem should be attempted to be reduced by/broken into/converted/connected to (depending on the workflow & core interaction function applied) that error structure, before trying to solve the original problem
   the first step of this workflow can include a query for insights to detect errors in the original problem/solution structures
other structures of ‘human error patterns’ can show up in other problem/solution structures than the ‘problem input variables/formats’ (like problem/solution assumptions, the problem statement, the solution metrics selected) which may distort the structures, leading to a pointless query bc the problem statement or solution metric is inaccurate
workflow fit:
   this is similar to the ‘break a problem into sub-problems’ workflow, but its specifically trying to break down the problem into sub-problems that are ‘known error types’, to see if the problem is created by (or equal to) a structure like a combination of errors which act as components constructing the problem
   this can be generalized to other error structures than ‘combinations’ and matched with the appropriate workflows:
      check if ‘combination of errors’=‘problem’: uses ‘break problem into sub-problems’ workflow, bc a ‘combination of errors’ can be used to build a ‘problem’, so a problem can be broken into those errors
      check if ‘sequence of errors’=‘problem’: uses ‘find root cause of problem & solve the cause instead’ workflow, bc an ‘error sequence=problem’ allows analyzing ‘problem cause’
   this is a variant of the ‘apply error structures to problem structures’ workflow, except it includes a function to select a solution automation workflow (‘break problem into sub-problems’) based on the error structure (‘combination of component errors’) to connect the problem/error structures, and the injection of insights that can identify error structures in problem/solution structures
identify solution input variables that maximize differences in solution output or identify solution output types & weight them by some metric to integrate/filter them into a solution
   example: for the ‘find a prediction function’ problem, find the most differentiating variables (number/value of constants/exponents, number of conditional/sub-range functions) producing the most differences in solutions (‘constant linear average function’, a ‘highly variable function intersecting with the most data points’, a ‘piece-wise function describing threshold-based phases of the function’) and weight these solutions to integrate/filter them according to a metric (like ‘probability of the prediction function occurring with these input variable types/dependencies/correlations & data set patterns’) to create an output solution
   the metric to weight them needs to be relevant to the problem/solution structures
      probability of a particular solution function is relevant to the operation of ‘weighting’ that solution function
         ‘weighting’ function involves assigning a ratio to an input's power to impact the output, based on how likely it is to be equal to the output (given that we're comparing the same data type, an input solution function and an output solution function)
         a ‘probability’ is a ‘ratio’ data type, so its relevant to the ‘weighting’ function which requires identifying & assigning a ‘ratio’ to an input
         what inputs are used to calculate the probability is a different problem, but the inputs to the probability should also be relevant to problem/solution structures
         using ‘function/variable patterns’ is relevant to predict the probability of the occurrence of a function having ‘equal/different patterns’
workflow fit: this is similar to ‘find the maximally different filtering structures that will filter solution space the most efficiently’, but is applied to ‘input solution variables’ rather than ‘solution space filters’
apply error cause once an error is identified as a way of determining understanding of the problem system & decide whether to solve that error type or adjusting solution based on error cause
example:
   an outlier would create an error in inaccuracy of predictions if incorporated into a prediction function, but the reason for the outlier (‘error cause’) may be that the connections between function variables are changing and the outlier is an early warning sign, or the outlier is the result of a set of interacting conditions creating an edge case that is expected occasionally but doesn't have to be included in a prediction function of other points & can be separated into its own conditional prediction function
   workflow fit: this is similar to workflows analyzing ‘solution success/failure cause’ but identifying error cause in this case is to specifically improve understanding of the problem system so the connections between problem/solution structures are more identifiable & optimizable
apply error structures to problems as a neutralization structure and as a way of generating related problems (sub-problems, component problems) to solve instead of or as part of the workflow
   example: apply ‘missing’ error structure to problem components like data points or variables for the ‘find a prediction function’ problem, to solve the problem for a subset of the data set/variables instead
   you can also apply correcting solution structures for each error type applied to get to the original solution format
      to correct the ‘missing’ error structure that manifests as missing data points or variables, add an offsetting solution structure of ‘iterate’ & ‘average’ to repeat the process for other ‘missing’ error applications & average them to get back to the original solution format, a prediction function for the complete data set
         data_set=>missing(data set points)*iterate(missing, data_set)*average(iterations)=>data set prediction function
      other—example: apply ‘opposite’ structure to the ‘find a prediction function’ problem, as in ‘find functions that are not predictive’ & differentiate from them to find the original solution format of the prediction function
      apply(‘opposite’, ‘prediction function’)=>‘non-predictive functions’=>apply (‘differences’, ‘non-predictive functions’)=>‘set of possible prediction functions’
   workflow fit: this is a variant of ‘apply solution structures to solutions to optimize them’ workflow
      this specific process is similar to that produced by applying other analysis, like core analysis, which would apply a ‘subset’ function to various problem structures since thats a core structure, and then integrate those structures in a structure that would produce the original solution format, but its another route to produce that process
identify systems where a particular solution/error structure will be relevant (an error that causes damage by neutralizing required (or all alternative optional) functions, or a solution that neutralizes many error types) as a way of filtering relevant solution/error structures from the set of all possible structures, to find structures that are relevant to avoid for the input problem system, & add as a solution metric filter or solution component structure, in case the solution metric filters are incomplete/missing or solution components are not already identified by other methods
   error type of ‘assuming simplicity (failing to identify complexity)’ can be caused by an error type of ‘failing to identify the impact on complexity of the output of assuming simplicity’
      when you assume simplicity, it reduces the incentive/benefit for an agent to be complex, and reduces the probability that they will be complex, causing a reduction in complexity or a reduction in showing complexity, if they were initially complex
      the assumption causes itself to be likelier to be true (self-fulfilling prophecy) if the assumer is more powerful than the assumed & if they are connected by a mutual/common investment
      this assumption can cause cascading errors in a system with a conceptual-probability interface structure like ‘powerful outliers’
      so solving a problem in a system with this condition (‘powerful outliers’ or the ‘potential for powerful outliers’) will require applying a solution/optimization structure to offset that error type, and a solution without this structure may not be optimal unless other structures of the solution provide a substitute/alternate for it
   find error/solution structures that can replace other structures and identify the most-reduced set of structures that can fulfill the most functions without neutralizing any relevant solution structures in a system
workflow fit: this is similar to the ‘find/derive error/solution structures & apply them as filters/components of solutions’ workflow, but includes a function of ‘finding useful alternate reduced error/solution structure sets’ to fulfill relevant error type filters or solution structures, and ‘finding systems where these structures are particularly relevant’ to avoid applying irrelevant structures
why this is useful: many solution/error structures are possible, and its useful to filter them to reduce the operations required or reduce the solution space
solution success cause: this works as a filter bc some structures are only relevant for some systems
apply interaction (connection functions, structure-building) & neutralizing (structure-invalidating) structures & apply them to generate the sets of possible systems to allowing identifying the true structure of a problem system (how a problem system works)
once the sets are generated, filter the possible system structures by other structures like probabilities, patterns & prediction tests (‘can a known system connection function be predicted by assuming this system structure’)
prediction tests can be filtered by relevance (‘predict important system connection functions, such as functions that are inputs to many other functions or required functions’)
why this is useful: misunderstanding a problem system is a major source of error types and solving that problem can solve other problems like ‘finding a specific connection function’, just by knowing how structures can interact given relevant neutralizing structures, which allows identifying possible & probable problem system structures
workflow fit: this is a specific variant of the ‘apply useful structures like interaction structures to problem/solution structures’ but is applied to the ‘problem system’ structure as a particularly useful way of drastically reducing other errors, given rules about how interaction/neutralizing structures can create systems, indicating its an important input to the problem system, meaning its particularly useful relative to other problem/solution structures, & solving for this error type in understanding the problem system can drastically reduce other errors to the point of not needing to solve them
solution success cause: this works bc if an interaction structure cant exist in a system given other neutralizing structures, its not relevant and doesn't need to be included in the solution space, allowing reduction of the solution space
apply rules/patterns of solution connections to identify when a more optimal solution is adjacent to a sub-optimal solution (to offset the error type ‘failing to pursue a direction when a more optimal solution is adjacent bc of prior cost from that pursuit’)
just like the ‘identify absolute minima/maxima’ problem solved by methods like ‘gradient descent’, optimal solutions are often adjacent to the selected sub-optimal solution, but aren't found bc of lack of understanding of solution patterns, connections & probabilities
solutions follow patterns revealing rules in their connections
   some solutions are connected by an adjacent function, like an ‘opposite’ function or ‘adding a variable/constant’
      applying common differences determining the difference between sub-optimal & optimal solutions is a good way to find an optimal solution quickly once you have an initial sub-optimal solution with methods like ‘approximation’ or ‘subset prediction’
   applying ‘standard function subset difference’ structures to a standard/initial solution (like a function predicting a data subset) to produce ‘maximally different’ or ‘highly probable given function patterns’ possible alternative functions & checking which of these functions are good predictors for randomly selected data subsets is a good way to reduce the solution space
   assuming that a consistent lack of value added by pursuing a particular direction will never produce value is a fallacy
      just like assuming that bc you haven't found a local maxima in a particular direction for a consistent period doesn't mean there isn't one, and bc functions & variables have patterns, maxima pattern probabilities can be used to predict their positions rather than applying random checks or applying a particular cost/benefit ratio to each pursued ‘direction’ variable value
      solutions are rarely an idealized simple continuous function
         more often in reality a solution function for the ‘find a prediction function’ problem might be:
         a set of subset functions, indicating emergent phase shifts at different threshold values of the independent variable
         a set of conditional functions connected by a network organized by input conditions
      applying these solution-connection rules to find adjacent optimal solutions to sub-optimal solutions is a way to work around the problem of ‘trial & error (trying every combination)’ to filter the solution space
   workflow fit: this is similar to the ‘apply changes to solutions to find other solutions, based on differences in intent/structure associated with those changes’ but applies the pattern interface to these solution structure connections to inject the useful interface component ‘probability’ into the success of solutions, given the applied solution success cause ‘patterns indicate a consistent connection that may be useful as a prediction rule to reduce uncertainty’ (so applying connection patterns as a guide of queries is a way to increase the probability of finding certainties like true variable connections)
identify & apply other important structures that offset error types (that are important across problems/systems) to problem/solution structures as a way of improving solutions given an initial sub-optimal solution
   example:
      applying ‘probability’ structures like patterns & other probability structures reduces the error types related to not considering probability structures
      such as the logical fallacy of ‘assuming there isn't value in a high-cost, low-reward direction bc of prior costs’ which doesn't account for outliers, threshold values & resulting phase shifts, & other probability structures indicating a complex system that isn't governed by just that cost/benefit
   workflow fit: this is a general variant of the above workflow ‘apply rules/patterns of solution connections’ wrapped in the function of identifying other important structures to consider when solving a problem optimally where they are not already known & deriving structures to neutralize that error type where there aren't already known structures to neutralize it & applying those neutralizing structures
   this is also related to the ‘apply certainty structures & other useful structures’ workflows, but in this case its applying structures that are ‘required’ to apply in order to avoid known error types, rather than just useful structures or structures associated with solutions or optimization structures like certainty (like ‘logic’, ‘understanding’, ‘info’ for a prediction problem)
   error structures can be generated by applying ‘difference’ structures to solution metric or optimization structures (‘different from solution’=‘error’ which may be relevant, like a solution-neutralizing error type)
find or generate structures of difference between multiple solutions & derive solution success cause of each, and apply those differences when one solution doesn't work, based on changes in solution success cause (conditionally generate different solutions based on changing inputs)
   example: different solutions to the ‘find a prediction function’ problem involve differences like:
      differences in variability between data set points
      number of traversed data set points of a function
      difference between the function & corresponding data points
   applying these variables to a sub-optimal solution when a solution is determined to be sub-optimal for a particular input condition (which may not be known) allows a rotation of the available/generated solutions to find one that is successful for a different input condition
apply the useful ‘maximum difference’ structure to all problem/solution components, like find ‘maximally different solutions’ and use those as an initial solution space to filter/adjust quickly, or ‘maximally different solution component sets’ or other problem/solution structures to assemble/filter/connect problem/solution components
   variant of the ‘apply maximally different solution filters’ workflow
find a solution & apply error types to a solution to identify if the error types produce the expected output of an error type
   example:
      for the ‘find a prediction function’ problem, identify an approximate prediction function & apply error types to it
         apply the ‘incorrect assumption’ error type
         does the prediction function have the expected errors if you change the assumptions (input variables & variable values, problem statement, other assumptions like that the independent variables are causative at all & not coincidentally correlated)
         apply the ‘incorrect causal structure’ error type:
         does the prediction function have the expected errors if you change its causal structures?
   solution success cause: this works as a solution automation workflow once a solution is known/generated, bc if applying these error types produces the expected errors (rather than improving the accuracy of the solution), the solution is likelier to be correct or approximately correct
convert problem to standard problem, find standard/base solution, and map difference types to intent to apply when a different problem is input that can be solved with differences applied to the standard solution
   example:
      when a function has multiple variables, apply difference type ‘partial’ to a derivative function and ‘subset’ to the ‘partial derivative’ input (find a partial derivative for one of the multiple variables)
      when you need to solve a different problem ‘find a derivative function for a function of x, y, & z’, that differs from a standard/base problem (like ‘find a derivative function for a function of x’), apply the differences that map with the intents of those differences
         the relevant ‘intent’ of adding ‘multiple’ structure to the ‘input variable’ structure (the intent relevant to the problem) is ‘find a derivative for each variable’
         to fulfill this intent, apply the intent map: ‘multiple’: [‘partial’, ‘subset’, ‘iterate’]
         apply the ‘partial’ and ‘subset’ structures to the standard solution once the ‘multiple’ structure is added to the standard problem
         in other words:
         to achieve a ‘multiple’ difference type applied to the input variable count of the original standard problem, apply ‘partial’ to the standard solution component (‘derivative’) of a ‘subset’ of each (‘iterate’) of the input variables
         an adjacent/direct intent of adding ‘multiple’ structure to the ‘input variable’ structure is (‘add a variable’ or ‘vary an existing variable’, where the variable is ‘number of input variables’)
      workflow fit: this is similar to applying the intent interface but adds a starting position of a ‘standard solution’ mapped to a ‘standard problem’, for problems where a standard solution is available, rather than for example assembling structures fulfilling various relevant intents, such as intents for sub-problem or problem component structures
      solution success cause:
         this works bc a standard known solution for a related standard problem offers an ‘interface’ problem to use as a base to apply changes to
         it uses the fact that ‘similar problems will often have similar solutions’
         it also uses the fact that a structure ‘mapping differences to intents’ is useful for ‘mapping solution differences to intents’ where intents can be derived from the problem, as ‘different solutions’ is a relevant object in this workflow
   apply useful vertex rules from other systems after standardizing to a problem system
      example: a useful physics rule is ‘like attracts like’
         what is a causative structure:
         applying this to other systems indicates the usefulness of ‘similarities’
         similar objects are often found together bc they are adjacent transforms of each other, and adjacent transforms are likelier than non-adjacent transforms
         this means ‘adjacent transforms’ (like minor changes to a sub-optimal solution to fit it to a new problem) are a useful structure to apply as well, as an initial solution
         applying the ‘similarity’ structure to a problem system would generate workflows such as:
         ‘apply solutions to similar problems & adjust to create similarities to the original problem system so the solution/problem fit/interact’
         ‘a similar structure to a similarity is a difference (which are only a few changes away, as they are almost opposite structures), so differences are also a useful structure that can be applied’
         ‘change the problem until its similar to the solution (connect problem/solution by equating them’
   why is it useful (solution success cause):
      this rule is particularly useful bc its:
         core/fundamental (that can be used to build other rules or be used as a foundation for other rules to develop)
         powerful (impacts many interactions)
         abstract (can be applied to many layers/systems bc it interacts with a core concept/structure like ‘similarity’)
   other useful rules can be identified using these & other attributes that differentiate useful rules
   the useful structures causing the useful rules (solution success cause) can also be identified & applied to problem/solution components
   workflow fit: this is similar to ‘apply insights to implement a solution automation workflow’, but is different in that it applies generally ‘useful rules’ (which have attributes like causative power, core importance, abstract structures) rather than insights (‘rules useful for specific intents like generating new understanding’), and also involves applying ‘solution success cause’ as an attribute of useful rules that is an alternative to applying the rule itself & allows abstracting/structuring the rule so it can interact with more systems
find a solution that is at least partially correct (like a solution that almost works) and determine solution success cause, then apply that as a solution metric filter or a solution structure like a solution component
   example: for the ‘find a prediction function’ problem, a partially correct solution function might work bc it has a ‘similarity’ to an ‘average function’
      once you know that, you can use that as:
         a solution component & apply other workflows to construct the rest of the solution, while including that component as an input requirement to other workflows
         a solution metric filter & apply that as inputs to other solution automation workflows, like:
         ‘create a structure of solution metric filters as solution requirements acting as limit structures in a solution template’
workflow fit: this is similar to the workflows of:
1. ‘solving one component of the problem at a time, then solving the next in the sequence’
2. ‘find a solution that is sub-optimal and apply changes to optimize it’
3. ‘apply inputs of solutions (like causes of solution success) to create solutions’
but combines other components of the other workflows, like the ‘starting position’ of workflow 2, a ‘function’ used in workflow 1, and the general ‘structure’ of workflow 3
identify possible solution structures that are the most testable (like ‘solution components’), as in the most verifiably true/false & apply those structures when building a solution
example: for the ‘find a prediction function’ problem, find the probable subset functions that can be proved as true/false the quickest & assemble a prediction function out of those functions or adjustments to them to fit in or fit together with the other functions (like in a subset function sequence or fit together for continuity/curvature or fit into the same function with adjustments)
workflow fit: this is similar to the solutions or workflows:
   ‘find the most different possibilities to form a solution space and start filtering/testing/adjusting those to find a solution’
   ‘find the vertex variables as an approximation to a complete function’
   ‘construct solution template using requirements as limit structures’
but optimizing for ‘testability’ (rather than ‘important variables’ or ‘maximum difference in possible solutions’ or ‘solution requirement limits’) as a solution filter to speed up finding a solution
apply structural interface to derive & build structures that will solve problem structures of a particular solution automation workflow and an organizing structure to integrate them once solved (like a ‘problem state sequence’ or a ‘solution metric filter’)
example:
just like the ‘prisoners dilemma’ structure is a structure that solves the question of ‘which choice is more often optimal, as in producing better outcomes more often’, and a ‘pinball machine’ structure solves the question of ‘which structures will a ball traverse given input variable values like direction/speed’, certain structures can resolve questions more efficiently than others
build a structure (like a network, maze, game, or sequence of gaps) to represent variables to resolve that are organized in a way that solves the problem according to the selected workflow
   if the problem is ‘resolving order of a set of variables’, build a sequence of gap structures & apply changes until each variable is resolved in the right input/output sequence, such as to solve the problem of ‘determining variables that cause each other in an input/output sequence’
   if the problem structure is a ‘complexity’, apply complexity-reduction structures or organizing structures like mapping/sorting/clustering/prediction algorithms to organize & resolve problem structures that are complexities
   if the problem is ‘finding out which set of path steps is optimal’, organize problem states in a maze structure, where error paths end in a barrier so an agent cant continue to the destination
these structures assign structure to workflow-specific problem structures (like sub-problems or interim problem states), then apply change & test functions until the problem structure is solved
   ‘break a problem into sub-problems & merge sub-solutions’
   ‘solve sub-problems one at a time in a sequence to help solve later sub-problems’
   ‘filter the solution space by applying highly reductive filters’
   ‘connect problem/solution with a format sequence’
fit with other workflows:
   rather than applying only a specific solution automation workflow to the problem, this workflow designs a structure to solve relevant problem structures (like ‘sub-problems’ or ‘the problem of connecting sub-problems’ or ‘changing problem state in a way that makes progress toward a solution metric’) by applying changes (like ‘move a ball around the pinball machine’ or ‘decide which route to go in the maze’) and testing if a solution metric is fulfilled (‘like hitting the right structures’ or ‘selecting a route that can exit the maze’)
this is a ‘mix’ structure applied to solution automation workflows:
   it injects a workflow ‘apply changes & filter output with solution metric tests’ into the workflow of ‘apply structural interface to design a structure that can solve problem structures with available change functions in those structures’ which can be applied to workflows where problem structures like sub-problems or interim problem states exist (like ‘reduce problem’ and ‘connect problem with solution’) instead of another workflow
   other solution automation workflows can be generated by applying interaction functions like apply/inject to solution automation workflows & their structures/components, to fulfill a solution automation workflow like ‘connect problem/solution’ (connect them using solution automation workflows & their structures/components/interaction functions)
identify workflow fit attribute (how a workflow fits with or relates to other workflows) to identify new variables of workflows or change types that can be applied to generate workflows using an input workflow or identify missing workflows
derive other interaction functions/structures between problem/solution components to derive solution automation workflows from those interactions
example:
‘break a problem into sub-problems and solve separately, then merge/integrate into solution’ works bc of the solution success cause:
interaction function: component function between components of a problem & the complete problem
   a problem can be broken into components (like core functions, or components of inputs like problem variables) like anything else, and ‘solving a component of the problem’ makes progress toward fulfilling the intent of ‘solving the complete problem’
other solution success causes:
   another reason a ‘component’ structure works when applied to a problem is that there may be existing/adjacent solutions for sub-problems rather than the original problem, so this structure offers a different way to connect problem/solution
   this also works bc it applies a known core interaction function of problems/solutions (‘reduce’) to the problem, ‘reducing’ it into sub-problems, so it's already moving closer to a solution given problem/solution interaction functions & their patterns
‘generate solution space of possible solutions & filter by solution metrics’ works bc of the solution success cause:
   interaction function: subset function between solution & solution space
      ‘a solution is necessarily a subset of all possibilities in the solution space’
      ‘the solution space is a subset of all possibilities’
   ‘apply changes to existing solutions to similar problems & test’ works bc of the solution success cause:
   interaction function: similarity sequence
      ‘similar objects, like similar problems, will have attributes in common, and so will objects related to them in a similar way (their solutions)’
‘apply changes to existing solutions known not to work & test’ works bc of the solution success cause:
   interaction function: difference structure
      ‘by definition a solution that works will be different from solutions that don't work’
   ‘start from system of certainties and apply certainty interaction functions to generate or reach a solution’ works bc of the solution success cause:
      interaction function: certainty interaction layer
         the solution is the target certainty, and applying interaction (connecting/changing) functions specific to the certainty interaction layer to an initial certainty set will generate other certainties, like the solution structure, and/or reduce uncertainties like the unfiltered solution space of possible solutions
these interaction structures (subset, component, similarity sequence, difference) offer different ways to connect problem & solution components, offering different ways to connect problems/solutions
   other interaction structures/functions can be derived/generated to connect problem/solution components in new ways
      any interaction function applied to problem/solution components that doesn't violate their definitions is a possible problem/solution interaction function
      filter these by which functions interact in a way that can make progress toward or fulfill a problem-solving intent (like ‘connect problem/solution’ or ‘reduce problem’)
apply other component structure patterns (like attributes/functions) as another problem-solution connection format
   change a problem (input) structure until it fulfills an attribute in a problem-solution connecting attribute sequence like the following, then fulfill the next attribute, etc
      attribute sequences
         ‘complex, organized, filtered, isolated, simple’
         ‘abstract, random, grouped, relevant, matched, compared, equated’
      function sequences
apply interface analysis to identify different versions of an insight or insight pattern in different interfaces, as insights are typically inputs to other insights so they can be used to generate them
   rather than generating/deriving specific rules to implement a workflow, pull & apply known specific rules to implement a workflow or components of it
      example: “occam's razor” is a known rule that can be used to fulfill the ‘filter solutions’ component of the ‘generate & filter possible solutions’ workflow
         other known/optimal attribute filters can be used as solution filters
         solution filters that filter the solution space the most optimally for a metric like speed/completeness, in the right sequence/structure can also be derived & applied
generate other variants of ‘solve a different problem bc of optimizations fulfilled by solving the other problem (like using existing/adjacent resources)’
   find adjacent structures (like approximations/alternates/interchangeables/simplifications/subsets) of problem/solution components and apply those as inputs to the solution automation workflow or interface query instead
   find overlapping problems with various problem components and solve for overlapping problems instead
   solve for the adjacent problem of ‘preventing problem inputs/outputs’ or ‘enabling solution inputs/outputs’ instead of the original problem
identify optimal problem to solve & solve that instead
the ‘find a prediction function’ problem has a default sub-problem of ‘isolate each variable’ and ‘check if this variable impacts the dependent variable’
   this is the wrong sub-problem to solve, bc:
      it may not be possible to isolate a variable's contribution to cause bc of a causal structure between causal variables that is neither totally independent or dependent
         if variables are independent, they can be isolated, and if they're totally dependent, one can be used as a substitute of another
         example of a variable with various dependence causal structure:
         variables considered independent:
         shape of the earth and the latest news headline
         one is very constant and the other seems highly variable, but is becoming more constant as fundamental attributes of the earth become more relevant to news
         variables considered dependent:
         the function caller requiring an output of a function, & the expected function output reliably created by the called function
         this isn't perfect dependence bc the outputs of a function may not be produced even if the code is correct, bc of other variables like hardware, but its a good approximation of dependence given the definition route of input as a causal structure
         variables with mixed dependence:
         variables involving structures of ambiguity may not be able to be isolated such as mixed causal structures like similar alternatives with unmeasurable differences having a conditional dependency between alternatives
         for a problem of ‘predict which equivalent route gets to the destination more optimally’:
         routes that seem independent (unrelated) may have built-in dependencies, like:
         ‘structural similarities’
         ‘opposite structures’
         ‘adjacent position’
         ‘route selection alternation preference, caused by a variation preference’
         if you take the left/right route around an obstacle, it may not be measurable whether you made a better decision to get to your destination, because the other outputs of your route (leaning or looking one way more frequently) may be so negligible as to
         resolve themselves
         never be measured in the first place
         offset by other decisions (taking a different route next time for variation)
         the routes may be equivalent or the differences may be immeasurable, and the output destination is the same, but the routes may also have a dependency that makes the input route variables (like left route frequency & right route frequency) of the output destination impossible to accurately isolate
         they also cant be combined accurately into one variable (like ‘route structure’ or ‘route adjacence’) bc this erases the info about their dependency & any conditions impacting one route or a route's selection
         whether you take a route may depend subconsciously on whether you took a different route previously (with a built-in preference for variation)
         the route frequencies and other route variables like route structure would both have to be incorporated in this case bc they cant be reduced
         one isolated component of the route variable might be sufficient to predict some variables (like whether a person develops a bias toward left/right), but they wont predict other variables (like vulnerability to natural disasters only impacting one route)
         if you cant identify/measure the structures like prediction potential or differences/connections in the route variable structures, you cant isolate them
         the dependency between alternatives may also be conditional
         ‘the left route only influences the right route if theres a condition changing their interaction or if an agent creates a dependency by choosing one based on the other’
everything has some connection to everything else
   example:
      ‘temperature’ or ‘collusion’ in a particular industry like pharmaceuticals may seem unrelated to a problem like ‘predict financial instrument markets’, and variables like ‘stock prices’ might seem more relevant, but:
      temperature can influence emotions, which are an important input to the stock market & other financial markets, and tropical temperatures lead to more tropical plants like coffee, and higher caffeine intake also leads to changes in emotions, and temperature also influences many commodity prices & prices influence other prices
      collusion can create unequal stress distribution, where market participants who play fair aren't making fair gains relative to malicious players, which has an impact on the stock market & regulatory environment, which can influence other regulatory environments, which is an input to financial markets
causal variables can have different causal structures like a causal loop or causal alignments between interaction layers, but that doesn't mean the causal relationship where they cause the dependent variable is incorrect, its just incomplete
example:
   incomplete causal loop
      ‘high temperate causes lack of work ethic, causing rise in temperature from pollution’
   incomplete causal interaction layer alignment
      causative variables can be causative on a different interaction layer like an abstraction level of the problem
      ‘power is a causative concept and input is a causative structure but that doesn't mean they contradict each other—they're aligning variables on different interfaces, bc power takes the form of inputs in the function format’
      ‘gravity can cause storms and so can electric charge, which are aligning causes on different interaction layers’
causative variables can have alternate causes (they might cause the dependent variable, but they might also be replaceable with alternate causes that also cause the dependent variable, with/out them)
   example:
      ‘any source of energy can cause a storm, not just one like wind or gravity’
   causative variables may seem interchangeable with other variable sets, while a hidden dependency exists, so they're both required in order to predict the dependent variable
      ‘a plant can develop according to the input variable of human intervention or the variable of biology rules’ is incomplete bc human intervention is in a causal loop structure with biology, and may be considered a subset or output of biology
so even if the program identifies that a variable is correlated with the dependent variable, & created a prediction function that seems to work at some level of accuracy for now, it still hasn't solved the problem bc it has applied inaccurate structures/definitions/connections rather than those based on understanding
   example:
   hiring based on biases like race/gender may seem to work well for a while, until social mobility & economic factors change, bc those may be the real determinants of success of particular groups, as certain groups had better education bc of better economic status, and the prediction function used an adjacent cause of ‘bias’ instead of the root causes of ‘economic status’ and ‘education’
   this makes the default sub-problem of ‘isolating variables & determining impact on dependent variable’ a shortcut to solving the problem, but it wont always have good results, bc of these inaccuracies in handling causal structures built in to the assumptions of solving the problem that way
so the right sub-problems to solve include:
   ‘how direct is the cause of this variable on the dependent variable’
   ‘how easy would it be to convert this variable into a causative variable’ (how much work would you have to do like ‘applying changes’ to make the variable cause the dependent variable)
this is where useful interface components like ‘filters’ can be applied
   filters reduce the solution space, just like reducing the set of possible variables by ‘directness of causation’ is useful
to find the optimal problem to solve in this specific case, you would need to apply the causal interface to identify the accurate structures of causation (like directness, uniqueness, inevitability of cause) to identify causal relationships, rather than proxy signals of causation like ‘correlation’ and ‘sequence’
to generalize finding the optimal problem to solve, you would apply interface components to determine if the original problem & problem structures like sub-problems are capable of solving the problem (fulfill solution metric like ‘accuracy’) or if there is potential for optimization by applying interface analysis
solution automation workflow:
   in order to find out if the original/default problem structures are sufficient to fulfill a solution metric, analyze the assumptions of the problem & problem structures to check for error types in those structures, implying that optimizations in the problem structures are possible, where there are default problem structures embedded in the problem statement or pulled from definitions or common solution workflows for a particular problem
error types in problem structures include:
   contextually accurate structures (like connections, such as when conditional/proxy variables are used instead of root causes)
      like fragile/forced conditions, such as whether a correlation or an adjacent cause like bias is used as a cause
   missing/incomplete interface components like cause structures
      bias is caused by over-prioritization of simplicity and by economic uncertainty (finite/unequal resources, leading to resource competition, leading to the development & use of filtering rules, such as hiring decisions)
      bias is not the only cause, as the primary root cause is economic status & education, which has a causal loop structure with bias (the ultimate root cause being physics, an interim root cause being brain structure, and a more direct root cause being lack of information/testing tools to offset bias)
      bias & economic uncertainty are both caused by economic status
      other causal structures exist between these variables, bc they encapsulate a vast degree of information (like history, decisions, agency, culture, habits, patterns, brain structures, and priorities), so can be treated as important or possibly even vertex variables
the problem structures & their error structures can be compared/connected/reduced/combined until the solution structures (like the ‘accuracy’ metric) are reached, to check if they can adjacently fulfill the solution metric
the ‘isolating variable impact’ sub-problem can create an ‘accurate prediction function’ solution format, but not in all cases of different input variable causal structures, so if the interim solution structure of the sub-problem structure of the “isolated variables' causal structures” have an error type (are incorrectly mapped to causal structures), they wont create the optimal ‘accurate prediction function’, fulfilling general optimization metrics like ‘robustness’ of the solution
apply solution automation workflows to the problem of ‘generate solution automation workflows’
example:
applying ‘break problem into sub-problems & merge sub-solutions’ takes the form of the following when applied to this problem:
sub-problem: generate solution automation workflow components
   sub-solution: to generate solution automation workflow components, find structures that can be used to build solution automation workflows (variables, structures like connection/interaction/difference structures)
sub-problem: find alternate inputs of solution automation workflow components
   sub-solution: apply different interfaces & interface components like abstraction & system contexts to find alternate inputs of solution automation workflows
sub-problem: generate new workflows
   sub-solution: apply interface analysis (& associated interface queries) to generate new workflows
      example:
         apply the solution automation workflow ‘apply useful interface components (like useful structures or system objects) to connect problem/solution’
   sub-solution: solve the alternate problems of ‘find new difference types to apply or find conversion functions between interfaces & find new interfaces to apply to find new workflows’
identify the errors of the perspectives generating each set of workflow variables & remove the errors to change the perspective to a new perspective that can generate other variables
   example:
      the perspective of problem/solution components has an error of ‘over-prioritizing the interaction layer involving those components’ which is an error bc it reduces the chances of finding workflows involving other components like ‘differences’
      to change this perspective into another (like a perspective where ‘differences’ are a core component that is likelier to be identified as an input to problem-solving components like workflows), apply interfaces or conversion functions between them
   solution success cause:
      this works bc there are alternative variable sets that can generate solution automation workflows, like ‘interactive components’, ‘function sequences’, ‘core interaction functions’, ‘causes of solution success’, ‘insights to optimize problem-solving’, etc—all of them are not required to be used to generate a workflow, even if you can find these structures in any system bc of their abstraction level
   solution requirement cause:
      this solution is necessary bc over-focusing on structures that are too certain/static will prevent difference types from being injected that can identify other variables
      its also necessary bc a variable thats adjacently structural on one interface may not be on another, so different variables on different interfaces makes sense as a requirement
identify causes answering the question of ‘why is one problem format easier to solve than another format for a problem/problem space’ & other questions relevant to problem-solving & apply them to make a problem easier to solve (optimize solutions)
   example:
      ‘breaking a problem into sub-problems’ makes a problem easier to solve bc of the cause that ‘separates variables causing the problem and they are easier to solve in isolation’
      apply this cause to generate other solution optimizations:
      apply this cause to the ‘connect problem & solution’ solution automation workflow to generate a new workflow or implement (specify) a workflow:
         isolate the variables of connection & connect them separately
generate inputs to causes of simplifying problems & other relevant process to problem-solving
   example:
      ‘adjacent structures for one problem format are more interactive than those of another format’ (adjacent functions interact in a way that fulfills one problem-solution format connection better than another problem-solution format connection)
         this is another cause of why a problem is easier to solve in a particular format
      this cause has inputs/requirements:
         there must be adjacent structures
         the adjacent structures in one format must be interactive
         their interactions must enable connection of the problem/solution in that format
      derive & generate the inputs to problem-simplifying solution success causes:
         determine the requirements of a problem-simplifying cause
      generate & apply those requirements
   example:
      identify that in order to find & apply adjacent interactive structures, they must exist
      in order for these to exist, in some cases the program will need to generate them
      in some cases, this will involve converting between formats, and the problem can be simplified to ‘converting to a format where adjacent interactive structures already exist’
      this amounts to ‘applying an interface’, which this insight path has derived as the solution
identify structures with input/output structures like sequences that can be used to connect problems/solutions for a generated set of problem/solution formats
   example:
      the solution automation workflow ‘generate possible solutions and filter them’ applies a ‘filter’ structure bc the problem format involves ‘many solutions’ and the solution format involves ‘one solution’, the problem format being to ‘find one solution out of the many possible solutions’, and a filter can reduce the number of an object that is output, so it fulfills a problem-solving intent to connect these formats, given that in order to find one solution out of many possible solutions, a program would have to reduce the number of possible solutions in some way, so ‘reduce’ functions/structures like ‘filters’ are useful
   generate possible problem/solution formats to connect by applying error structures
      the above ‘finding’ problem has an error structure of ‘excess possible solutions’ or ‘lack of solution filters’
      most structures would be problematic in particular contexts
         some structures are especially errors when applied to problem/solution components, like a ‘lack of solution filters’ as opposed to ‘any lack of filters’
      other error structures involve structures that can be solved with core interaction functions
         ‘connect’ solves the error structure of ‘lack of connection between problem & solution’
         ‘mix’ solves the error structure of ‘find new solution’ or ‘find a random combination to solve obfuscation problem’
         ‘break & combine’ solves the error structure of ‘complexity added by combined problem components’ (where sub-problems are simpler to solve)
this isn't the same as ‘apply core interaction functions like reduce/connect & basic structures known to solve problems like input-output sequences’, its saying ‘generate & apply all core structures/functions that are relevant to solve problems, given that error structures are also fundamental structures connectible to solutions with core interaction functions’ and also ‘generate & apply all possible problem/solution formats and find structures that connect them to generate solution automation workflows’
identify insights that optimize problem-solving, identify their variables & generate them to apply them dynamically to generate solution automation workflows
   example:
      the workflow ‘break problem into sub-problems & combine sub-solutions’ applies the insight ‘smaller/simpler problems are easier to solve’
   how to identify this insight:
      pull patterns from problem-solving and identify that problem-solvers often apply the workflow of ‘use unit/basic/simple case to solve the problem, then check if it holds with other cases’
      pull definitions & fit them in a way that makes sense (doesn't contradict any factual rules)
         ‘small’ is an adjacent term to ‘simple’, ‘unit’, ‘basic’, ‘low-cost’ or ‘adjacent’ because they are all similar to the concept of ‘easy’, so it fits into the rule ‘smaller problems are easier to solve’
         ‘simple’ is a synonym of ‘easy’
      test if changes to a problem make it easier to solve, and filter which changes succeed in making it easier to solve
         if a problem is ‘climbing a ladder’, test if changing the problem to ‘climbing a step’ makes it easier to solve—if so, identify that the change was ‘reducing’ or ‘simplifying’ the problem to its ‘unit’ case, and test if this change simplifies other problems as well
   how to identify/generate other insights that make problems easier to solve:
      any change that has an opposite effect (‘change’, ‘reduce’, ‘neutralize’, ‘remove’) on a component/cause/variable/structure of an error structure, or its generative system, without causing other error structures
      any function that connects inputs/outputs more efficiently than another function can make a problem of a relevant structure easier to solve (a more efficient ‘reduction’ function may be a better solution like ‘filter’ than a less efficient ‘reduction’ function like ‘sort then filter’)
solve problem for one component/variable/structure of the problem, then add other components of the problem and check if solution holds or modify it to fit the new component
   this is a specific case of the general workflow ‘simplify the problem, solve the simpler version, then check if the simple solution holds when complexity is added, or adjust the simpler solution for complicating structures’
   its also a variant of the ‘break problem into sub-problems & combine sub-solutions’ solution automation workflow
find any missing workflows by applying ‘change’ functions to workflows to find variants like general/specific versions of a workflow
apply a workflow to various problems to find changes to apply to workflows to adapt them to specific problems, and add those changes to a general solution automation workflow to generate other workflows
convert workflows to other workflows to find any missing variables/functions to generate one workflow from another & apply those to generate other workflows
identify & apply commonly useful structures by standardized structures of usefulness (like ‘which structures have outputs that have common inputs for other functions’, ‘which are capable of generating many other components’, ‘which are inputs to structures of usefulness’) to all functions/variables/components of problem/solution components
apply error structures to problem/solution components like solution automation workflows (like ‘missing’ error structure applied to ‘workflows’) & known solutions to those error structures, and generate/identify new/specific error types in the problem-solving system & apply solutions to those error types to fulfill general problem-solving intents
generate structures of difference (like ‘difference sequences’) and apply as components of workflows (similar to applying interaction structures, solution structures, optimization structures, relevance structures, or not-error structures)
solution success cause: this works bc in order to get from problem to solution, you have to apply differences to the problem/solution until they're equivalent, bc they start as different, which is the problem
   a difference can be an error type:
      a value is different from another value, like an expected/required value
   similarly, a problem is different from a solution
      the problem ‘find a value’ is different from the solution of ‘a value’
in order to find error types (‘problematic’ differences), you can generate difference structures & find optimal routes between the inputs/outputs as a source of solution automation workflows
   to find solution automation workflows, first generate & identify problems in a known system and find optimal routes between inputs/outputs (formatted as starting/ending positions)
   then identify the interface components interacting with those routes
apply differences to solutions that are known not to work (can be calculated as definitely not solutions, or have been tried and are known not to work) bc a solution that works would have to be different from these in order to solve the problem
derive patterns of differences between solutions that definitely don't work and solutions occupying structures like areas of ambiguity where the solutions in the area might work but are more difficult to calculate, and reduce solution space to those areas, and apply those patterns of difference to calculate solutions that might work given solutions that definitely are known/calculable as not solutions
derive structures of solution spaces that position/structure solutions in a way that adjacence indicates probability of working, so areas can be ruled out with threshold metrics representing boundaries
   rather than applying a simplistic similarity metric, apply a metric that determines actual similarities based on relevance to the problem
      example of grouping methods to determine adjacence in a solution space:
         structural similarities can indicate similar functionality, or they can be insignificant to a particular problem and caused by an unrelated factor (like two similar structures created in different positions by similar boundary structures but having different functionality bc of the different position), so grouping solutions by structural similarities is one way that can contextually represent similarity of solution success for a particular problem
      combinations of components of workflows/interface queries (interactions, differences) that can act in isolation (a workflow can be formatted as a set of interactions)
      vertex variables
      apply solution ranges where solution formats can be reduced to approximations of solutions or adjacent components to solutions (a theorem can be framed as adjacent to a proof)
apply pattern-identification methods of differences between solution automation workflows, isolate into difference types, & add to variables determining difference between workflows to generate them
   example of applying differences to generate alternate solution automation workflows (different routes to connect problem & solution)
      standard basic workflow: trial & error
      alternate workflow: apply ‘trial & error’ to filtered solution space of ‘adjacent’ solutions
      the differences between these workflows include:
         container structure (one workflow contains the other)
         different position of components (position of ‘trial & error’ in one is different from position of ‘trial & error’ in another)
         one workflow has an attribute applied to filter solution space (‘adjacent’)
      these can be reduced to known interface component variables, even if the variables interact in a new way thats different from other workflows:
         ‘structure’ variable including structures like containers & positions
         ‘workflow component’ variable including other workflows, solution spaces, solution metric filters
         ‘core component’ variable including attributes/functions/objects (like ‘adjacent’ attribute, which is relevant to intents like ‘finding solutions quickly’ or ‘finding feasible solutions with existing resources’)
         ‘interaction function’ variable including interaction functions like ‘apply’ & ‘filter’
      so an example of generating a workflow from another workflow using differences between these two example workflows would involve applying three logic rules that can be used to connect the two example workflows, which can presumably connect/generate other workflows:
      1. ‘apply workflow components as inputs of core interaction functions’
         example application of this rule: ‘inject one workflow into the other’
      2. ‘apply relevant core components like attributes to workflow components like the solution space to generate a different workflow’
         apply any remaining general logic rules once the workflows are generated:
      3. ‘filter generated workflows by whether they connect components in a way that can connect problem input & solution output’
other differences between alternate workflows may identify other variables that can be used to generate one workflow from another
solution success cause: why does this method work to generate different workflows?
   analyzing ‘differences’ between workflows is by definition relevant to identifying variables between workflows, which can by definition be used to generate them
   one workflow is a more abstract version of the other, and varying abstraction level is by definition applicable to many contexts like inputs, within a range
given these solution success causes (inputs of success of the solution), we can derive other methods to generate workflows:
   ‘abstract a workflow within a certain range of abstraction’ (so it doesn't lose its meaning)
   “apply definitions of relevant components to workflows like ‘differences’ with an interaction function like ‘generate’ that is relevant given their definition like ‘variables’”
derive & apply workflow template/structure to fill with workflow variable values once interface analysis is fully applied to workflows
   this means once components like standard/base workflows, common workflows & workflow patterns, & workflow variables are identified
   this is an alternative to writing static function logic to design interface queries
derived alternate merged interfaces (like the meaning interface) to avoid sub-optimal metrics inherent to each interface perspective, where the problem can be adjacently solved
   the ‘survival’ and ‘evolution’ perspectives have their own disadvantages, so merge them into an interface to avoid these disadvantages
      ‘survival’ disadvantages include errors like ‘over-identifying threats’, from survival functions like ‘constantly checking for threats’
      ‘evolution’ disadvantages include errors like ‘excess change, incompatible with other changes’, from evolutionary functions like ‘gene modification/activation/addition/movement’
   applying the survival function ‘check for threats’ to identify a threat of the change type that is ‘incompatible changes with other changes’ is one way to merge those components on these interfaces (using the error of one interface to fix an error in the other interface, assuming no other errors are adjacent in these merged positions)
apply definition of any other components of the workflow that haven't been applied in other solution automation workflows or workflow-generating workflows
   an ‘insight path’ is a ‘shortcut to find new useful info’ so apply the definition of ‘shortcut’
      by definition, its a method that requires less work
      so generate methods requiring less work as an initial solution space
      solution success cause: this works bc of the overlap between the definitions of adjacence and efficiency
         paths are ‘efficient’ bc they require less work, meaning they may use ‘adjacent’ resources (nodes or methods)
identify the shortest, lowest-cost, most adjacent or otherwise most efficient/optimized route/function to known solutions from problem definitions and identify patterns in these routes or the variables/components/structures/formats enabling them to be optimized (sub-interfaces, definitions, interaction levels), and generate function to iterate through those patterns based on usefulness for a problem definition, and apply those patterns
apply trial & error except with the injection of the concept of ‘solution progress’ as a filter of multiple methods attempted in parallel, derived from maximizing difference types based on filter capacity (solution progress assessed similar to learning from error/cost)
identify the most different structures you can apply (like directions of motion) and apply them iteratively, checking for progress toward the solution metric based on solution patterns of progress (accept costs of these types up to a particular threshold or other structure), and stopping the pursuit of any differences that don't match solution progress patterns
identify & apply alternative inputs (variables) of solution automation workflows to create other workflow-generating workflows, given the definition of ‘generative’ meaning ‘an input to’, and given that this workflow for the default inputs (variables) of workflows is already stored elsewhere, so this applies ‘alternative’ as a transform
   example of alternative inputs:
      to identify that a method is especially useful out of all the possible methods, you can use alternate variable sets:
         start with solution metrics as limits creating the structure/template of a solution, and fill it in or work backwards
         common components of useful solutions, or components of commonly useful solutions
      adjacent combinations of available resources at the origin state (problem position)
      core interactive components
      these are alternates bc they have equivalent/similar input/output when applied to this problem of ‘identifying a useful method in a large set of possible methods’
      a function (structure of connections between specific inputs & outputs) can have alternate formats like (a set of filters, differences, intents, or requirements)
      these are alternate versions of the function that don't lose info expressed by the function, and they can serve as alternate inputs to the function outputs, since the function itself is also an input
iterate through optimization priorities & apply other optimizations to workflows, like ‘find alternatives to optimize for robustness’, which when applied to workflows would generate the previous ‘apply alternative inputs to workflows’ workflow-generating workflow
apply useful interface components (like ‘interactivity’, ‘ambiguity’, ‘incentive’, ‘contradiction’, ‘requirement’) to fulfill core interaction functions (like connect, complete, reduce, merge) with interface structures for optimized querying
   fulfill optimization intent ‘avoid full interface standardization’
      map interactive structures across interfaces for queries that support avoiding full interface standardization
      map corresponding structures across interfaces to avoid standardization to an interface in case an isolated operation like ‘identify one object’ is needed
         this allows for an efficient interface query that executes only the conversions necessary & keeps the processing on one base interface, pulling in isolated structures from other interfaces with sub-queries as needed
standardize interface queries & solution automation workflows to other interfaces (to avoid converting problem system to a particular interface just to implement a workflow)
apply other interfaces like ‘structure’ interface to specify a query/workflow and interfaces like ‘concept’ to abstract a query/workflow

One skilled in the art, after reviewing this disclosure, may recognize that modifications, additions, or omissions may be made to the solution automation module 140 without departing from the scope of the disclosure. For example, the designations of different elements in the manner described is meant to help explain concepts described herein and is not limiting. Further, the solution automation module 140 may include any number of other elements or may be implemented within other systems or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component in this disclaimer is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1. A method optionally comprising relating functions of the following:
problem/solution components
solution/problem spaces
related problem/solution networks
solution metrics
problem input & solution output formats
general problem-solving intents
insight paths, including specific insight paths like solution automation workflows (insight paths that relate problem/solution formats)
problem/solution metadata
useful structures identified by or in relation to a particular problem/solution structure (like an interface query or solution automation workflow), as a source of variables to generate useful structures (like differences) in other workflows
related object fit: conversions required to create this object from an adjacent/standard object of the same type
simplification: standardized, simplified statement of the structure (like a simplified version of a workflow)
components to fulfill problem-solving intents
problem-solution core interaction functions
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’)
functions to generate relevant structures for problem-solving intents, like ‘solution/error’ structures
functions to apply core intents (generate/find/derive/apply) or problem-solving intents to problem/solution components like solution automation workflow insight paths & interfaces
known useful components that can be applied as optional default solution structures to apply problem-solving intents

2. The method of claim 1, wherein example implementations of problem/solution components are related with example components to fulfill problem-solving intents, such as problem-solution core interaction functions & solution automation workflows.

3. The method of claim 1, wherein example implementations of problem/solution core interaction functions (like ‘reduce’, ‘remove’, ‘filter’, or ‘connect’) are used to relate the problem & solution components,
like ‘reduce the problem’ or ‘connect problem & solution structures’.

4. The method of claim 1, wherein example implementations of functions to generate solution automation workflows may vary solution automation workflow variables like:
‘vertex functions’, ‘implementation structures of varying certainty’, ‘solution success cause’, ‘solution/error/implementation structures’, ‘problem/solution components’, and ‘adjacent core interaction functions’.

5. The method of claim 1, wherein example implementations of problem/solution components can be used to fulfill core intents & core interaction function intents for relevant problem/solution structures (like ‘variable connections’).

6. The method of claim 1, wherein example implementations of problem/solution components (like functions generating relevant structures for problem-solving intents, like ‘solution/error’ structures), may interact with solution automation workflows in any way, including: being applied as input to specific solution automation workflows, applying solution automation workflows, and being applied to generate solution automation workflows.

7. The method of claim 1, wherein example implementations of known useful components that can be applied as optional default solution structures may apply an interface query where known useful components are organized in a structure that relates problem/solution components to fulfill a problem-solving intent.

8. A non-transitory computer-readable medium containing instructions that, when executed by a processor, cause a device to perform operations, the operations comprising relating functions of the following:
problem/solution components
solution/problem spaces
related problem/solution networks
solution metrics
problem input & solution output formats
general problem-solving intents
insight paths, including specific insight paths like solution automation workflows (insight paths that relate problem/solution formats)
problem/solution metadata
useful structures identified by or in relation to a particular problem/solution structure (like an interface query or solution automation workflow), as a source of variables to generate useful structures (like differences) in other workflows
related object fit: conversions required to create this object from an adjacent/standard object of the same type
simplification: standardized, simplified statement of the structure (like a simplified version of a workflow)
components to fulfill problem-solving intents
problem-solution core interaction functions
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’)
functions to generate relevant structures for problem-solving intents, like ‘solution/error’ structures
functions to apply core intents (generate/find/derive/apply) or problem-solving intents to problem/solution components like solution automation workflow insight paths & interfaces
known useful components that can be applied as optional default solution structures to apply problem-solving intents

9. The non-transitory computer-readable medium of claim 8, wherein example implementations of problem/solution components are related with example components to fulfill problem-solving intents, such as problem-solution core interaction functions & solution automation workflows.

10. The non-transitory computer-readable medium of claim 8, wherein example implementations of problem/solution core interaction functions (like ‘reduce’, ‘remove’, ‘filter’, or ‘connect’) are used to relate the problem & solution components,
like ‘reduce the problem’ or ‘connect problem & solution structures’.

11. The non-transitory computer-readable medium of claim 8, wherein example implementations of functions to generate solution automation workflows may vary solution automation workflow variables like:
‘vertex functions’, ‘implementation structures of varying certainty’, ‘solution success cause’, ‘solution/error/implementation structures’, ‘problem/solution components’, and ‘adjacent core interaction functions’

12. The non-transitory computer-readable medium of claim 8, wherein example implementations of problem/solution components can be used to fulfill core intents & core interaction function intents for relevant problem/solution structures (like ‘variable connections’).

13. The non-transitory computer-readable medium of claim 8, wherein example implementations of problem/solution components (like functions generating relevant structures for problem-solving intents, like ‘solution/error’ structures), may interact with solution automation workflows in any way, including: being applied as input to specific solution automation workflows, applying solution automation workflows, and being applied to generate solution automation workflows.

14. The non-transitory computer-readable medium of claim 8, wherein example implementations of known useful components that can be applied as optional default solution structures may apply an interface query where known useful components are organized in a structure that relates problem/solution components to fulfill a problem-solving intent.

15. A system comprising: one or more processors; and one or more non-transitory computer-readable media containing instructions that, when executed by the one or more processors, cause the system to perform operations, the operations comprising relating functions of the following:
problem/solution components
solution/problem spaces
related problem/solution networks
solution metrics
problem input & solution output formats
general problem-solving intents
insight paths, including specific insight paths like solution automation workflows (insight paths that relate problem/solution formats)
problem/solution metadata
useful structures identified by or in relation to a particular problem/solution structure (like an interface query or solution automation workflow), as a source of variables to generate useful structures (like differences) in other workflows
related object fit: conversions required to create this object from an adjacent/standard object of the same type
simplification: standardized, simplified statement of the structure (like a simplified version of a workflow)
components to fulfill problem-solving intents
problem-solution core interaction functions
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’)
functions to generate relevant structures for problem-solving intents, like ‘solution/error’ structures
functions to apply core intents (generate/find/derive/apply) or problem-solving intents to problem/solution components like solution automation workflow insight paths & interfaces
known useful components that can be applied as optional default solution structures to apply problem-solving intents

16. The system of claim 15, wherein example implementations of problem/solution components are related with example components to fulfill problem-solving intents, such as problem-solution core interaction functions & solution automation workflows.

17. The system of claim 15, wherein example implementations of problem/solution core interaction functions (like ‘reduce’, ‘remove’, ‘filter’, or ‘connect’) are used to relate the problem & solution components,
like ‘reduce the problem’ or ‘connect problem & solution structures’.

18. The system of claim 15, wherein example implementations of functions to generate solution automation workflows may vary solution automation workflow variables like:
‘vertex functions’, ‘implementation structures of varying certainty’, ‘solution success cause’, ‘solution/error/implementation structures’, ‘problem/solution components’, and ‘adjacent core interaction functions’

19. The system of claim 15, wherein example implementations of problem/solution components can be used to fulfill core intents & core interaction function intents for relevant problem/solution structures (like ‘variable connections’).

20. The system of claim 15, wherein example implementations of problem/solution components (like functions generating relevant structures for problem-solving intents, like ‘solution/error’ structures), may interact with solution automation workflows in any way, including: being applied as input to specific solution automation workflows, applying solution automation workflows, and being applied to generate solution automation workflows.

21. The system of claim 15, wherein example implementations of known useful components that can be applied as optional default solution structures may apply an interface query where known useful components are organized in a structure that relates problem/solution components to fulfill a problem-solving intent.
